(19) United States
(12) Patent Application Publication
(10) Pub. No.: US 2007/0222740 A1
(43) Pub. Date: Sep. 27, 2007

(54) Display apparatus, image data providing apparatus, and controlling method

(75) Inventor: Keitaro Hanada, Soraku-gun (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/386,659

(22) Filed: Mar. 23, 2006

(30) Foreign Application Priority Data
Mar. 22, 2006 (JP) 2006-79786

(51) Int. Cl. G09G 3/36

(52) U.S. Cl. 345/102

(57) ABSTRACT

A display system is arranged such that an image data providing apparatus calculates a brightness level of original image data (by brightness level calculating section), generates brightness-adjusted image data by increasing brightness of the original image data based on the brightness level (by brightness adjusting section), and transmits the brightness-adjusted image data to a display apparatus (by image transmitting section). The display apparatus receives the brightness-adjusted image data from the image data providing apparatus (by image receiving section), and controls a backlight such that the backlight reduces its luminance according to how much the brightness of the brightness-adjusted image data is increased from that of the original image data (by backlight adjusting section). With this arrangement, it is possible to allow the image data providing apparatus to generate the brightness-adjusted image data whose brightness is increased in order to reduce the luminance of the backlight.

This Nonprovisional application claims priority under 35 U.S.C. § 119(a) on Patent Application No. 2006/79786 filed in Japan on Mar. 22, 2006, the entire contents of which are hereby incorporated by reference.

### FIELD OF THE INVENTION

The present invention relates to a display apparatus including a light source (such as a backlight or front light), an image data providing apparatus, and a control method.

### BACKGROUND OF THE INVENTION

In a portable-type apparatus, reduction in power consumption therein prolongs the usage time of a battery, thereby allowing the battery to be smaller. This contributes to miniaturization of the portable-type apparatus. Meanwhile, in an apparatus provided with a liquid crystal display device, power consumption of a backlight of the liquid crystal device accounts for a large portion of the whole power consumption. Thus, there is a strong demand for reduction in the power consumption of the backlight of the liquid crystal display device in such an apparatus.

In a portable telephone having a television receiving function, a backlight thereof has a largest power consumption therein. Thus, battery operable time (usage time of the battery) is largely influenced by whether the backlight is turned on or off, and how much is luminance of the backlight. In general, a display screen becomes easy to watch when the backlight is lit with a high luminance, while the display screen becomes difficult to watch when the backlight is lit with a low luminance. Moreover, optimal luminance is also dependent on how bright surrounding is. Because the use of the backlight significantly influences battery operable time, the luminance of the backlight is controlled to prolong the battery operable time.

There is a conventional art in which levels of video signals to be supplied are controlled according to a maximum level among levels of inputted video signals and luminance of a backlight is controlled at the same time, thereby attaining reduction in power consumption of the backlight.

Here, FIG. 15 is a functional block diagram illustrating an arrangement of a display apparatus 800. The display apparatus 800 attains low power consumption of a backlight thereof by calculating a brightness level of the image data and reducing luminance of the backlight while increasing brightness of the image data based on the brightness level of the image data.

As illustrated in FIG. 15, the display apparatus 800 is provided with an image receiving section 801, a brightness level calculating section 802, a filter generating/selecting section 803, a brightness adjusting section 804, a backlight adjusting value calculating section 805, a backlight adjusting section 806, a display device 807, and a backlight 808.

The image receiving section 801 receives original image data that is to be displayed thereon. The brightness level calculating section 802 calculates a brightness level of the original image data. Here, the brightness level is, for example, maximum brightness or average brightness of one image. The filter generating/selecting section 803 generates or selects, based on the brightness level calculated by the brightness level calculating section 802, a brightness adjusting filter that is to be used by the brightness adjusting section 804. The brightness adjusting section 804 adjusts the brightness of the original image data, and outputs the brightness-adjusted image data. The brightness adjusting section 804, for instance, performs a filter process based on gamma correction. The brightness-adjusted image data generated by the brightness adjusting section 804 is displayed on the display device 807.

On the other hand, the backlight adjusting value calculating section 805 calculates out a backlight value for adjusting luminance of the backlight 808 based on the brightness level of the original image data, the brightness level having been calculated by the brightness level calculating section 802. The backlight adjusting section 806 controls the luminance of the backlight 808 based on the backlight adjusting value calculated by the backlight adjusting value calculating section 805.

The following Patent Documents are named as conventional documents relating to the present invention: US patent application publication 2005/0110740 (published on May 26, 2005); and US patent application publication 2005/0206776 (published on Sep. 22, 2005))

US patent application publication 2005/0110740 describes an art for reducing power consumption. In the art described in US patent application publication 2005/0110740, when light intensity of a backlight is decreased, brightness of pixels of an image is increased thereby compensating the decrease in light intensity of the backlight. US patent application publication 2005/0110740 also describes how to obtain pixel values by calculation.

Moreover, US patent application publication 2005/0206776 discloses an art in which brightness and color saturation of an image is corrected by a backlight parameter extracted from the image.

However, in the conventional arrangements, the display apparatus should perform necessary processes for increasing the brightness of the image data and decreasing the luminance of the backlight as much as the brightness of the image data is increased. That is, the display apparatus should perform, by itself, the calculation of the brightness level, the generation or selecting operation of the brightness adjusting filter, brightness adjustment of the image data, and calculation of the backlight adjusting value. However, an amount of these calculations is generally huge. Because of this, the display apparatus should have a complicated device configuration inevitably. Moreover, the calculations should be performed on real-time basis in order to concurrently receive and display data provided via broadcasting or the Internet. In this case, the brightness adjustment would possibly deteriorate the image in quality. However, because the display apparatus has processing capacity necessary for the real-time process, there are cases that the brightness adjustment is impossible or results in poor image quality.

### SUMMARY OF THE INVENTION

In view of the aforementioned problem, an object of the present invention is to provide a display apparatus, an image data providing apparatus, and a control method, each of which allows an increase of brightness of image data without deteriorating image quality, while decreasing luminance of a light source as much as the brightness is increased.

The present invention is arranged as follows in order to attain the object: An image data providing apparatus according to the present invention is for providing, to a display apparatus including a light source for illuminating a display screen from at least either of front and rear of the display screen, image data that is to be displayed on the display apparatus. The image data providing apparatus according to the present invention is arranged to include:

a brightness level calculating section for calculating a brightness level, which is a property regarding brightness of original image data;

a brightness adjusting section for generating brightness-adjusted image data from the original image data by increasing the brightness of the original image data according to the brightness level calculated by the brightness level calculating section; and

a image transmitting section for transmitting, to the display apparatus, the brightness-adjusted image data generated by the brightness adjusting section.

A method according to the present invention is for controlling an image data providing apparatus for providing, to a display apparatus including a light source for illuminating a display screen from at least either of front and rear of the display screen, image data that is to be displayed on the display apparatus. The method according to the present invention is arranged to include:

(a) calculating a brightness level, which is a property regarding brightness of original image data;

(b) generating brightness-adjusted image data from the original image data by increasing the brightness of the original image data according to the brightness level calculated in the step (a); and

(c) transmitting, to the display apparatus, the brightness-adjusted image data generated in the step (b).

Here, the light source of the display apparatus is only required to be able to illuminate the display screen from either of front or rear of the display screen. For example, the light source may be a backlight or a frontlight.

A display apparatus according to the present invention includes a light source. The display apparatus according to the present invention is arranged to include:

an image receiving section for receiving brightness-adjusted image data from an image data providing apparatus; and

a light source-adjusting section for controlling the light source such that the light source reduces its luminance according to how much brightness of the brightness-adjusted image data is increased from the brightness of the original image data.

A method according to the present invention is for controlling a display apparatus including a light source for illuminating a display screen from at least either of front and rear of the display screen. The method according to the present invention is arranged to include:

receiving brightness-adjusted image data from an image data providing apparatus; and

controlling the light source such that the light source reduces its luminance according to how much brightness of the brightness-adjusted image data is increased from brightness of original image data.

In this arrangement, the image data providing apparatus calculates the brightness level of the original image data and generates the brightness-adjusted image data form the original image data by increasing the brightness of the original image data. Then, the image data providing apparatus transmits the brightness-adjusted image data to the display apparatus. Then, the display apparatus receives the brightness-adjusted image data from the image data providing apparatus and display it thereon, while controlling the light source thereof such that the luminance of the light source is reduced according to how much the brightness of the brightness-adjusted image data is increased from that of the original image data. Here, the light source of the display apparatus is only required to be able to illuminate the display screen from either of front or rear of the display screen. For example, the light source may be a backlight or a frontlight.

With this arrangement, it is possible to attain low power consumption of the display apparatus by increasing the brightness of the image data and decreasing the luminance of the light source as much as the brightness of the image data is increased. Because the calculation of the brightness level of the original image data and the generation of the brightness adjusting image data are performed in the image data providing apparatus, the display apparatus can display the received brightness-adjusted image data as it is. That is, the display apparatus does not need to perform the calculation of the brightness adjustment.

Therefore, the display apparatus can have a simple device configuration. Moreover, when the image data providing apparatus can utilize a device of higher performance than can the display apparatus and the image data providing apparatus can generate the brightness-adjusted image data in advance, it is possible to take enough time for preparing the brightness-adjusted image data. This results in better brightness adjustment.

An image data providing apparatus according to the present invention is for providing, to a display apparatus including a light source for illuminating a display screen from at least either of front and rear of the display screen, image data that is to be displayed on the display apparatus. The image data providing apparatus according to the present invention is arranged to include:

a brightness level calculating section for calculating a brightness level, which is a property regarding brightness of original image data; and

a brightness level transmitting section for transmitting, to the display apparatus, the brightness level calculated by the brightness level calculating section.

A method according to the present invention is for controlling an image data providing apparatus for providing, to a display apparatus including a light source for illuminating a display screen from at least either of front and rear of the display screen, image data that is to be displayed on the display apparatus. The method according to the present invention is arranged to include:

(a) calculating a brightness level, which is a property regarding brightness of original image data; and

(b) transmitting, to the display apparatus, the brightness level calculated in the step (a).

A display apparatus according to the present invention includes a light source for illuminating a display screen from at least either of front and rear of the display screen. The display apparatus according to the present invention is arranged to include:

a brightness level receiving section for receiving, from an image data providing apparatus, a brightness level, which is a property regarding brightness of original image data;

a brightness adjusting section for generating brightness-adjusted image data from the original image data by increasing the brightness of the original image data according to the brightness level received by the brightness level receiving section; and

a light source adjusting section for controlling the light source such that the light source reduces its luminance according to how much the brightness adjusting section increases the brightness of the original image data.

A method according to the present invention is for controlling a display apparatus including a light source for illuminating a display screen from at least either of front and rear of the display screen. The method according to the present invention is arranged to include:

(a) receiving, from an image data providing apparatus, a brightness level, which is a property regarding brightness of original image data;

(b) generating brightness-adjusted image data from the original image data by increasing the brightness of the original image data according to the brightness level received in the step (a); and

(c) controlling the light source such that the light source reduces its luminance according to how much brightness of the brightness-adjusted image data is increased from brightness of original image data in the step (a).

In this arrangement, the image data providing apparatus calculates the brightness level of the original image data and transmits it to the display apparatus. The display apparatus, which receives the brightness level from the image data providing apparatus, generates the brightness-adjusted image data from the original image data by increasing the brightness of the original image data according to the brightness level. The display apparatus displays the brightness-adjusted image data, while controlling the light source such that the light source reduces its luminance according to how much the brightness of the brightness-adjusted image data is increased from that of the original image data.

Here, the light source of the display apparatus is only required to be able to illuminate the display screen from either of front or rear of the display screen. For example, the light source may be a backlight or a frontlight.

Therefore, it is possible to realize low power consumption of the display apparatus by increasing the brightness of the image data while decreasing the luminance of the light source as much as the brightness of the image data is increased. Because the calculation of the brightness level of the original image data is performed in the image data providing apparatus, the display apparatus only need generate the brightness-adjusted image data by using the received the brightness level. That is, the display apparatus does not need to perform the calculation of the brightness level.

Therefore, the display apparatus can have a simple device configuration. Moreover, when the image data providing apparatus can utilize a device of higher performance than can the display apparatus and the image data providing apparatus can generate the brightness level in advance, it is possible to take enough time to prepare the brightness level. This results in highly accurate result.

An image data providing apparatus according to the present invention is for providing, to a display apparatus including a light source for illuminating a display screen from at least either of front and rear of the display screen, image data that is to be displayed on the display apparatus. The image data providing apparatus is arranged to include:

a brightness level calculating section for calculating a brightness level, which is a property regarding brightness of original image data;

a brightness adjusting filter determining section (brightness adjusting filter generating/selecting section) for determining a brightness adjusting filter, based on the brightness level calculated by the brightness level calculating section;

a brightness adjusting filter transmitting section for transmitting, to the display apparatus, (i) the brightness adjusting filter determined by the brightness adjusting filter determining section, or (ii) filter identification information that identifies the brightness adjusting filter determined by the brightness adjusting filter determining section;

a light source adjusting value calculating section for calculating a light source adjusting value used for controlling the light source of the display apparatus such that the light source reduces its luminance according to how much the brightness adjusting filter determined by the brightness adjusting filter determining section increases brightness; and

a light source adjusting value transmitting section for transmitting, to the display apparatus, the light source adjusting value calculated by the light source adjusting value calculating section.

A method according to the present invention is for controlling an image data providing apparatus for providing, to a display apparatus including a light source for illuminating a display screen from at least either of front and rear of the display screen, image data that is to be displayed on the display apparatus. The method according to the present invention is arranged to include:

(a) calculating a brightness level, which is a property regarding brightness of original image data;

(b) determining (generating or selecting) a brightness adjusting filter, based on the brightness level calculated in the step (a);

(c) transmitting, to the display apparatus, the brightness adjusting filter determined in the step (b), or filter identification information that identifies the brightness adjusting filter determined in the step (b);

(d) calculating a light source adjusting value used for controlling the light source of the display apparatus such that the light source reduces its luminance according to how much the brightness adjusting filter determined in the step (b) increases brightness; and

(e) transmitting, to the display apparatus, the light source adjusting value calculated in the step (d).

A display apparatus according to the present invention includes a light source for illuminating a display screen from at least either of front and rear of the display screen. The display apparatus according to the present invention is arranged to include:

a brightness adjusting filter receiving section for receiving, from an image data providing apparatus, a brightness adjusting filter or filter identification information that identifies the brightness adjusting filter;

a brightness adjusting section for generating brightness-adjusted image data from original image data by increasing brightness of the original image data by applying (i) the brightness adjusting filter received by the brightness adjusting filter receiving section or (ii) the brightness adjusting filter associated with the filter identification information received by the brightness adjusting filter receiving section;

a light source adjusting value receiving section for receiving a light source adjusting value from the image data providing apparatus; and

a light source-adjusting section for controlling the light source according to the light source adjusting value received by the light source adjusting value receiving section.

A method according to the present invention is for controlling a display apparatus including a light source for illuminating a display screen from at least either of front and rear of the display screen. The method according to the present invention is arranged to include:

(a) receiving, from an image data providing apparatus, a brightness adjusting filter or filter identification information that identifies the brightness adjusting filter;

(b) generating brightness-adjusted image data from original image data by increasing brightness of the original image data by applying (i) the brightness adjusting filter received in the step (a) or (ii) the brightness adjusting filter associated with the filter identification information received in the step (a);

(c) receiving a light source adjusting value from the image data providing apparatus; and

(d) controlling the light source according to the light source adjusting value received in the step (c).

In this arrangement, the image data providing apparatus calculates the brightness level of the original image data and determines the brightness adjusting filter. The image data providing apparatus then transmits, to the display apparatus, the brightness adjusting filter thus determined or filter identification information for the brightness adjusting filter thus determined. Moreover, the image data providing apparatus calculates out the light source adjusting value that is for controlling the light source of the display apparatus such that the light source reduces its luminance according to how much the brightness adjusting filter increases the brightness. The image data providing apparatus transmits the light source adjusting value to the display apparatus. The display apparatus employs the brightness adjusting filter received from the image data providing apparatus or the brightness adjusting filter associated with the filter identification information thereof received from the image data providing apparatus (in this case, brightness adjusting filters are preferably pre-stored in the display apparatus in association with respective pieces of filter identification information), and thereby displays the brightness-adjusted image data whose brightness is increased from that of the original image data. Moreover, the display apparatus controls the light source based on the light source adjusting value received from the image data providing apparatus.

Here, the light source of the display apparatus is only required to be able to illuminate the display screen from either of front or rear of the display screen. For example, the light source may be a backlight or a frontlight.

Thus, it is possible to realize low power consumption of the display apparatus by increasing the brightness of the image data while decreasing the luminance of the light source as much as the brightness of the image data is increased. The calculation for generating or selecting the brightness-adjusted filter, and the calculation of the light source adjusting value are performed in the image data providing apparatus. Because of this, the display apparatus only need generate the brightness adjusted image data and control the light source by using the received brightness adjusting filter (or the filter identification information) and the light source adjusting value. That is, the display apparatus does not need to perform the calculation for generating or selecting the brightness adjusting filter, the calculation of the light source adjusting value, and the calculation of the light source adjusting value for controlling the light source of the display apparatus such that the light source reduces its luminance according to how much the brightness of the brightness-adjusted image data is increased from that of the original image data.

Thus, the display apparatus can have a simple device configuration. Moreover, when the image data providing apparatus can utilize a device of a higher performance than can the display apparatus and the image data providing apparatus can prepare the brightness adjusting filter (or filter identification information) and the light source adjusting value in advance, it is possible to take enough time to prepare brightness adjusting filter (or filter identification information) and the light source adjusting value. Thus, it is possible to attain highly accurate result.

Furthermore, the image data providing apparatus and the display apparatus may be realized by using a computer. In this case, the scope of the present invention encompasses (i) control programs for controlling a computer to function as the respective sections, thereby realizing the image data providing apparatus or the display apparatus by using the computer, (ii) computer-readable recording medium storing the same, and (iii) computer data signals embodied in carrier waves, each computer data signal including program code of the control program.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a functional block diagram illustrating an arrangement of an image data providing apparatus and a display apparatus of a display system of one exemplary arrangement of one embodiment according to the present invention.

FIG. 2 is a functional block diagram illustrating an arrangement of a model of the display system according to the present invention. In this model, a fixed filter is employed to any original image data.

FIG. 3 is a functional block diagram illustrating an arrangement of a model of the display system according to the present invention. In this model, a filter is employed to original image data only when the original image data has a brightness level darker than a threshold value (fixed value).

FIG. 4 is a functional block diagram illustrating an arrangement of a model of the display system according to the present invention. In this model, a most suitable filter is selected, according to the brightness level of the original image data, from among pre-provided filters.

FIG. 5 is a functional block diagram illustrating an arrangement of a model of the display system according to the present invention. In this model, a most suitable filter is dynamically generated according to brightness level of the original image data.

FIG. 6 is a functional block diagram illustrating a content providing apparatus and a display apparatus of a display system of a modification of the exemplary arrangement as illustrated in FIG. 1.

FIG. 7 is a functional block diagram illustrating an image data providing apparatus and a display apparatus of a display system of another exemplary arrangement of the embodiment of the present invention.

FIG. 8 is a functional block diagram illustrating arrangements of a content providing apparatus and a display apparatus of a display system of a modification of the exemplary arrangement of FIG. 7 of the embodiment according to the present invention.

FIG. 9 is a functional block diagram illustrating an image data providing apparatus and a display apparatus of a display system of still another exemplary arrangement of the embodiment according to the present invention.

FIGS. 10(a) and 10(b) are explanatory views explaining spatial determination of a brightness level of the image data in the embodiment of the present invention.

FIGS. 11(a) and 11(b) are explanatory views explaining temporal determination of a brightness level of the image data in the embodiment of the present invention.

FIG. 12 is an explanatory view illustrating an example of a brightness adjusting filter of the embodiment of the present invention.

FIG. 13 is an explanatory view illustrating an example of a brightness adjusting filter of the embodiment of the present invention.

FIG. 14 is a view explaining parameters in the embodiment of the present invention.

FIG. 15 is a functional block diagram illustrating an arrangement of a display apparatus according to a conventional art.

### DESCRIPTION OF THE EMBODIMENTS

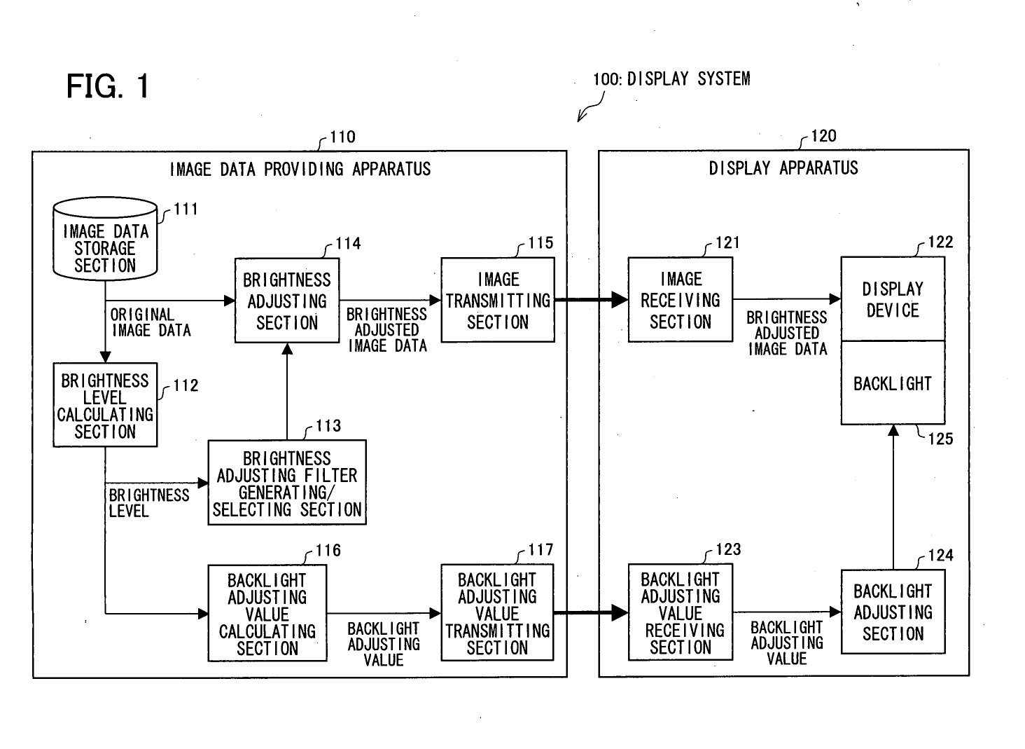

One embodiment of the present invention is described below, referring to FIGS. 1 to 14.

For example, as illustrated in FIG. 1, a display system according to the present embodiment is provided with a display apparatus having a backlight (light source), and an image data providing apparatus for providing, to the display apparatus, image data that is to be displayed on the display apparatus.

In order to avoid a high power consumption of the display apparatus, the display system is so arranged that brightness of the image data is increased while luminance of the backlight is reduced as much as the brightness of the display apparatus is increased. It is required to perform necessary processes for increasing the brightness of the image data and decreasing the luminance of the backlight as much as the brightness of the image data is increased. That is, it is required to perform the calculation of the brightness level, the generation or selecting operation of the brightness adjusting filter, brightness adjustment of the image data, and calculation of the backlight adjusting value (light source adjusting value). An amount of these calculations is generally huge. In this display system, part or all of the calculations are performed in the image data providing apparatus that provides the image data.

With this, the display apparatus is no longer required to perform complicated calculations at a high speed, and can be simplified in its device configuration, compared with the case where all such calculations are performed in the display apparatus. This makes it possible to attain low power consumption in the display apparatus. Moreover, because the image data providing apparatus can perform these calculations with facility having sufficient processing capacity and with sufficient time, this arrangement attains better brightness adjustment. Thus, this arrangement is especially suitably applicable to a display that displays data upon reception of the display data via broadcasting, Internet distribution, or the like.

It should be noted that the present invention is not limited to the present embodiment in which the display apparatus having a backlight as its light source is discussed by way of example. The light source of the present invention is only required to be able to illuminate a display screen (display surface) of the display apparatus from at least either of front and rear of the display screen. More specifically, the light source may be, e.g., a front light that is provided in the front of the display screen, in lieu of the backlight provided in the rear of the display screen.

[Models]

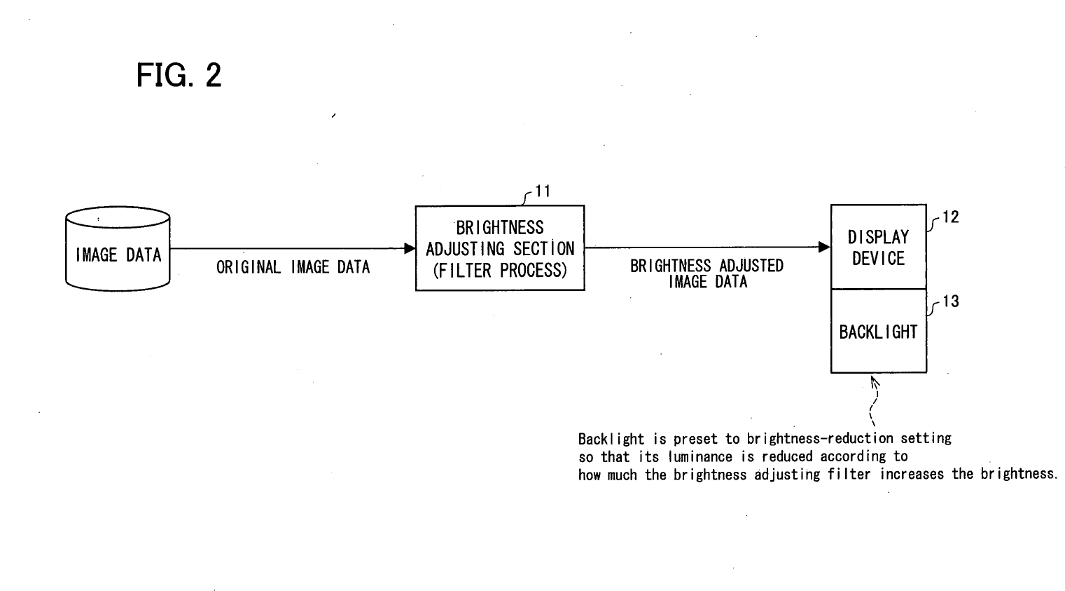

In the following, four basic models of the display system of the present invention are described, referring to FIGS. 2 to 5. It should be noted that the four models (FIGS. 2 to 5) may be arbitrarily combined with any of the exemplary arrangements 1 to 3 (FIGS. 1, 6 to 9) later described.

(A) Fixed Filter (for all times)

FIG. 2 is a functional block diagram illustrating an arrangement of a basic model in which a fixed filter is employed to any original image data.

As illustrated in FIG. 2, the brightness adjusting section 11 employs, to the original image data, a brightness adjusting filter whose setting is fixed. Thereby, brightness-adjusted image data with increased brightness is generated by the brightness adjusting section 11. The display device 12 displays the brightness-adjusted image data thereon. Here, the backlight 13 is so preset to brightness-reduction setting (the backlight 13 reduces its luminance according to how much the brightness is increased by the brightness adjusting filter of the brightness adjusting section 11).

(B) Fixed Filter (Conditional)

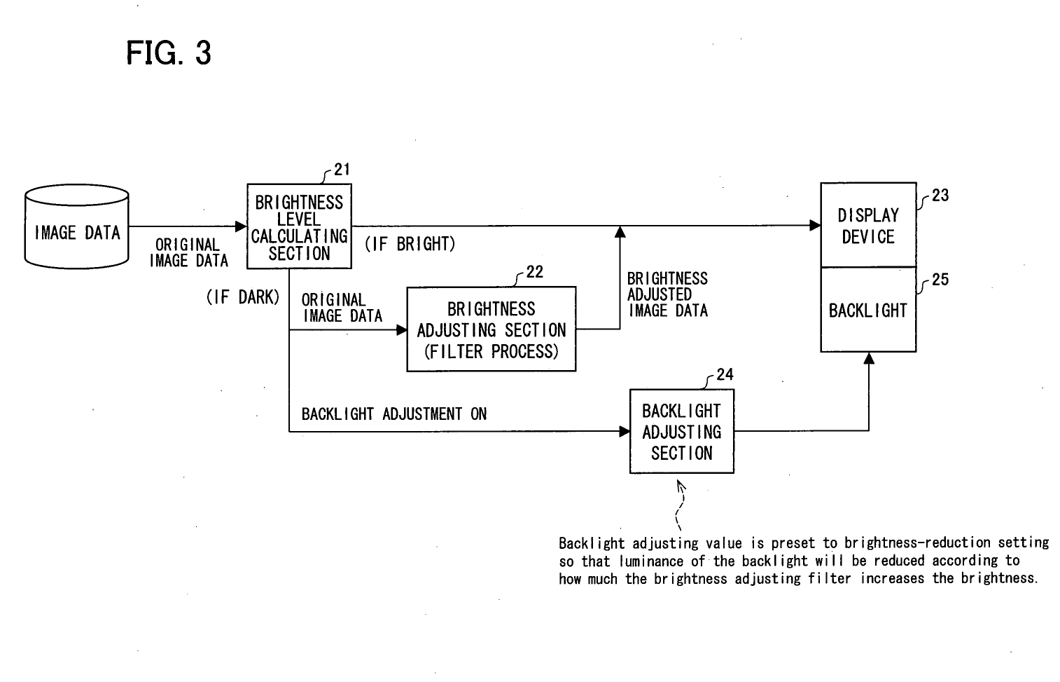

FIG. 3 is a functional block diagram illustrating an arrangement of a model in which a filter is employed only if the brightness level of the original image data is darker than a threshold value (fixed value). Here, the brightness level is a property of the brightness of the original image data. More specifically, for example, the brightness level may be an average brightness or maximum brightness in one image (i.e., one frame of the image) in case where the original image is still image. In case where the original image is dynamic image, an average brightness or maximum brightness in an image in a given time period recent to a current time period may be used as the brightness level.

As illustrated in FIG. 3, the brightness level calculating section 21 calculates out (works out) the brightness level of the original image data. If the brightness level is higher or equal to the threshold value (fixed value), the brightness level calculating section 21 outputs the original image data as it is. Then, the display device 23 displays the original image data as it is. Here, the backlight 25 illuminates at a normal luminance (i.e., without adjustment to reduce its luminance).

On the other hand, when the brightness level of the original image data is darker than the threshold value (fixed value), the brightness level calculating section 21 outputs the original image data to the brightness adjusting section 22, and outputs a control signal to the backlight adjusting section 24, the control signal validating the adjustment of the backlight. Then, the brightness adjusting section 22 employs a brightness adjusting filter whose setting is fixed and is for the cases where the brightness level is darker than the threshold value. Thereby, brightness adjusting data with an increased brightness is generated by the brightness adjusting section 22. Then, the display device 23 displays the brightness-adjusted image data thereon. Here, the backlight adjusting section 24 controls the backlight 25 to reduce its luminance according to how the brightness is increased by the brightness adjusting filter of the brightness adjusting section 22. It is preset how much the luminance of the backlight 25 is reduced by the backlight adjusting section 24 (in other words, the backlight adjusting value is preset).

(C) Filter Selection

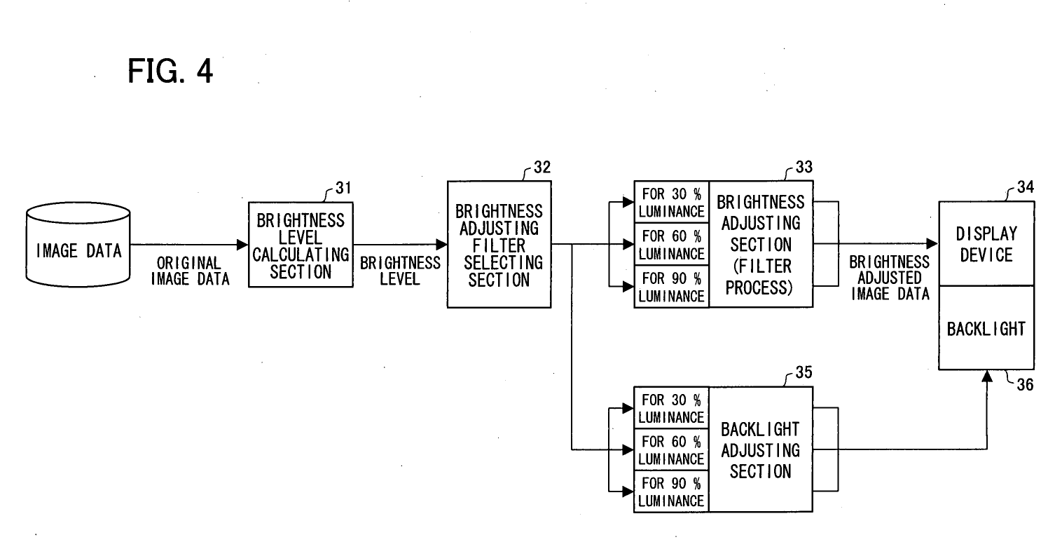

FIG. 4 is a functional block diagram illustrating an arrangement of a model in which a most suitable filter is selected, according to the brightness level of the original image data, from among pre-provided filters.

As illustrated in FIG. 4, the brightness level calculating section 31 calculates out (works out) the brightness level of the original image data. Then, the brightness adjusting filter selecting section 32 selects out one brightness adjusting filter from among plural brightness adjusting filters pre-provided per brightness level. A filter ID for identifying the brightness adjusting filter may be used in order for the brightness adjusting filter selecting section 32 to specify the selected brightness adjusting filter to the brightness adjusting section 33 and the backlight adjusting section 35.

After that, the brightness adjusting section 33 employs the brightness adjusting filter selected by the brightness adjusting filter selecting section 32. With the selected brightness adjusting filter, the brightness adjusting section 33 generates the brightness-adjusted image data whose brightness is increased. Then, the display device 34 displays the brightness-adjusted image data.

Here, the backlight adjusting section 35 controls the backlight 36 to reduce its luminance according to how much the brightness is increased by the brightness adjusting filter selected by the brightness adjusting filter selecting section 32. Associations of backlight adjusting values with filter adjusting filters for use in the brightness adjusting section 33 are pre-registered in the display apparatus. The backlight adjusting values also indicate how much the luminance of the backlight 36 is reduced by the backlight adjusting section 35 according to which filter adjusting filter is used by the brightness adjusting section 33. For example, if the luminance of the backlight 36 is reduced to 30%, a brightness adjusting filter for 30% luminance is used.

(D) Dynamic Generation of Filter

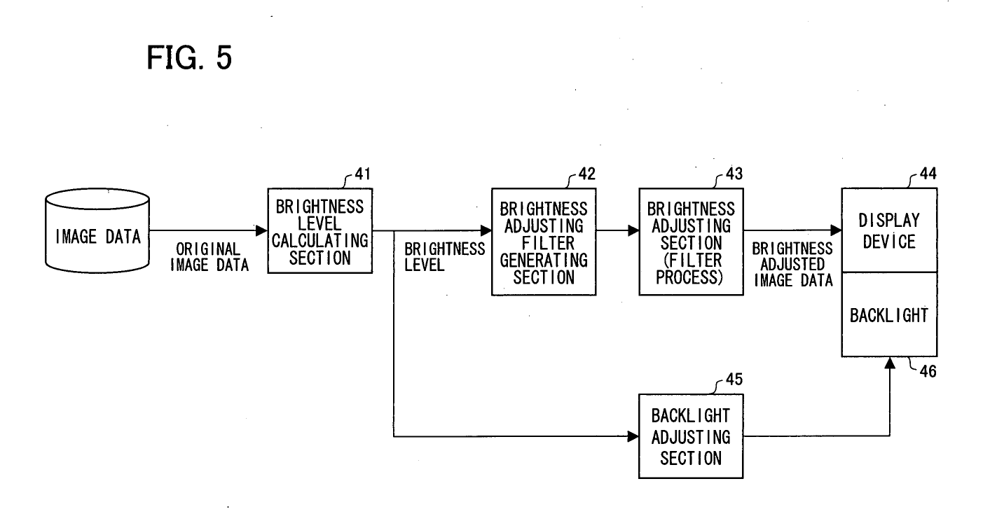

FIG. 5 is a functional block diagram illustrating an arrangement of a model in which an optimal filter is dynamically generated according to the brightness level of the original image data.

As illustrated in FIG. 5, the brightness level calculating section 41 calculates out (works out) the brightness level of the original image data. Then, based on the brightness level worked out by the brightness level calculating section 41, the brightness adjusting filter generating section 42 generates the brightness adjusting filter. An example of the generation of the brightness adjusting filter is as follows. Brightness levels are associated with γ values of gamma curve in advance. the brightness adjusting filter generating section 42 obtains a γ value associated with the brightness level worked out by the brightness level calculating section 41, and works out a γ curve from the γ value, thereby obtaining the brightness adjusting filter.

Then, the brightness adjusting section 43 employs the brightness adjusting filter generated by the brightness adjusting filter generating section 42. With the brightness adjusting filter, the brightness adjusting section 43 generates the brightness-adjusted image data whose brightness is increased. Then, the display device 44 displays the brightness-adjusted image data.

Here, the backlight adjusting section 45 controls the backlight 46 such that the backlight 46 reduces its luminance according to how much the brightness is increased by the brightness adjusting filter generated by the brightness adjusting filter generating section 42. Specifically, the backlight adjusting section 45 works out (determines) a backlight adjusting value according to the brightness level calculated by the brightness level calculating section 41. Based on the backlight adjusting value, the backlight adjusting section 45 controls the backlight 46. Brightness levels and backlight adjusting values are associated with each other in advance.

[Arrangement Examples]

In the following, exemplary arrangements 1 to 3 of the display systems of the present embodiment are described referring to FIGS. 1, 6 to 9. Note that the arrangements 1 to 3 (FIGS. 1, 6 to 9) is modifiable, e.g., by implementing any of the four models (FIGS. 2 to 5) described above.

(1): Brightness Level Calculation, Filter Determination, and Brightness Adjustment, Performed by Image Data Providing Apparatus

As an exemplary arrangement 1, a display system 100 is described below referring to FIG. 1. FIG. 1 is a functional block diagram illustrating an arrangement of an image data providing apparatus 110 and a display apparatus 120 in the display system 100.

As illustrated in FIG. 1, the display system 100 includes the image data providing apparatus 110 for transmitting image data, and the display apparatus 120 for receiving and displaying the image data. In the display system 100, the image data providing apparatus 110 works out (calculates) a brightness level, determines the filter to use, and adjusts the brightness of the image data. The display apparatus 120 displays the received image data as it is.

The image data providing apparatus 110 transmits the backlight adjusting value which will be used for determining the luminance of the backlight 125 (light source) in the display apparatus 120. The backlight adjusting value may be, for example, a brightness level of the original image data, or parameter that indicates how much the image is corrected. The display apparatus 120 adjusts the luminance of the backlight 125 according to the backlight adjusting value transmitted thereto.

More specifically, the image data providing apparatus 110 and the display apparatus 120 are arranged as follows.

The image data providing apparatus 110 is provided with an image data storing section 111, a brightness level calculating section (brightness level calculating means) 112, a brightness adjusting filter generating/selecting section (brightness adjusting filter determining means) 113, a brightness adjusting section (brightness adjusting means) 114, an image transmitting section (image transmitting means) 115, a backlight adjusting value calculating section (light source adjusting value calculating means) 116, and a backlight adjusting value transmitting section (light source adjusting value transmitting) 117.

The image data storing section 111 stores therein the original image data. The original image data is data for display on the display device 122 of the display apparatus 120, but has not been adjusted in brightness. The original image data may have any format, as long as the format allows the brightness level calculation and brightness adjustment based on the brightness level thus calculated out. That is, the original image data may be of still image or of dynamic image. Of course, the original image data may be RGB data of bit map format.

The brightness level calculating section 112 calculates out (works out) the brightness level of the original image data read out from the image data storage section 111. The brightness level will be described later.

The brightness adjusting filter generating/selecting section 113 determines (generates or selects) the brightness adjusting filter, based on the brightness level worked out by the brightness level calculating section 112. The brightness adjusting filter generating/selecting section 113 may generate the brightness adjusting filter according to a predetermined algorism, or selects the brightness adjusting filter from among a plurality of brightness adjusting filters registered in advance.

The brightness adjusting section 114 employs the brightness adjusting filter determined (generated or selected) by the brightness adjusting filter generating/selecting section 113, and thereby generates the brightness-adjusted image data whose brightness is increased.

The image transmitting section 115 transmits, to the display apparatus 120, the brightness-adjusted image data generated by the brightness adjusting section 114.

The backlight adjusting value calculating section 116 calculates out, based on the brightness level worked out by the brightness level calculating section 112, a backlight adjusting value for controlling the backlight 125 of the display apparatus 120 such that the backlight 125 reduces its luminance according to how much the brightness is increased by the brightness adjusting filter used by the brightness adjusting section 114.

The backlight adjusting value transmitting section 117 transmits, to the display apparatus 120, the backlight adjusting value calculated by the backlight adjusting value calculating section 116.

Moreover, the display apparatus 120, which includes a display device 122 having the backlight 125, is further provided with an image receiving section (image receiving means) 121, a backlight adjusting value receiving section (light source adjusting value receiving means) 123, and a backlight adjusting section (light source adjusting means) 124.

The image receiving section 121 receives the brightness-adjusted image data from the image data providing apparatus 110. The display device 122 displays the received brightness-adjusted image data as it is.

The backlight adjusting value receiving section 123 receives the backlight adjusting value from the image data providing apparatus 110.

The backlight adjusting section 124 controls the backlight 125 according to the backlight adjusting value received by the backlight adjusting value receiving section 123.

The display device 122 includes a driving circuit. That is, in case where a liquid crystal panel is used, the display device 122 includes a liquid crystal panel, a liquid crystal driving circuit for performing signal processing and generation of driving pulses in order to drive the liquid crystal panel. Moreover, the backlight 125 includes a backlight driving circuit for turning on and off the backlight 125 according to input signals inputted thereto.

In the display system 100 with this arrangement, the image data providing apparatus 110 calculates the brightness level of the original image data and generates the brightness-adjusted image data form the original image data by increasing the brightness of the original image data. Then, the image data providing apparatus 110 transmits the brightness-adjusted image data to the display apparatus 120. Then, the display apparatus 120 receives the brightness-adjusted image data from the image data providing apparatus 110 and displays it thereon, while controlling the backlight 125 thereof such that the luminance of the backlight 125 is reduced according to how much the brightness of the brightness-adjusted image data is increased from that of the original image data.

With this arrangement, it is possible to attain low power consumption of the display apparatus by increasing the brightness of the image data and decreasing the luminance of the backlight 125 as much as the brightness of the image data is increased. Because the calculation of the brightness level of the original image data and the generation of the brightness adjusting image data are performed in the image data providing apparatus 110, the display apparatus 120 can display the received brightness-adjusted image data as it is. That is, the display apparatus 120 does not need to perform the calculation of the brightness adjustment.

Therefore, the display apparatus 120 can have a simple device configuration. Moreover, when the image data providing apparatus 110 can utilize a device of higher performance than can the display apparatus 120 and the image data providing apparatus 110 can generate the brightness-adjusted image data in advance, it is possible to take enough time for preparing the brightness-adjusted image data. This results in better brightness adjustment.

In this arrangement, the image data providing apparatus 110 calculates out the backlight adjusting value for controlling the backlight 125 of the display apparatus 120 such that the backlight 125 reduces its luminance according to how much the brightness adjusting means increases the brightness of the original image data, and transmits the backlight adjusting value to the display apparatus 120. The display apparatus 120, which receives the backlight adjusting value from the image data providing apparatus 110, controls the backlight 125 based on the backlight adjusting value.

Thus, the calculation of the backlight adjusting value is performed in the image data providing apparatus 110. The display apparatus 120 can control the backlight 125 based on the received backlight adjusting value as it is. That is, the display apparatus 120 does not need to calculate the backlight adjusting value for decreasing the luminance of the backlight 125 of the display apparatus 120 according to how much the brightness is increased from that of the original image data.

Therefore, the display apparatus 120 can have a simple device configuration. Moreover, when the image data providing apparatus 110 can utilize a device of higher performance than can the display apparatus 120 and the image data providing apparatus 110 can generate the backlight adjusting value in advance, it is possible to take enough time for preparing the backlight adjusting value. This results in highly accurate result.

It should be noted that it would be possible to similarly attain equivalent image quality and low power consumption in a display device provided with no backlight adjusting section 124, if the display device is arranged to give an message to a user to ask him/her to reduce luminance of a backlight manually (e.g., “please darken the backlight manually.”).

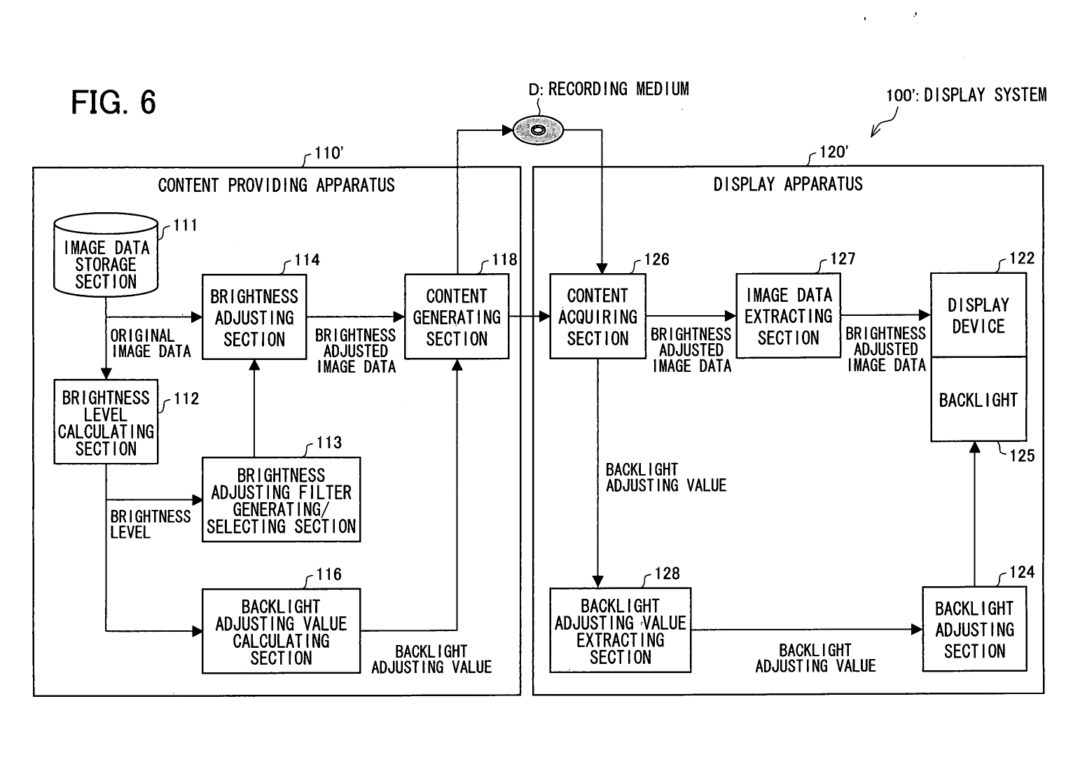

Next, a display system 100′, one modification of the arrangement 1, is described below, referring to FIG. 6, which is a functional block diagram illustrating arrangements of a content providing apparatus 110′ and a display apparatus 120′ of the display system 100′.

The display system 100′ is different from the display system 100 (FIG. 1) in that a content that contains brightness-adjusted image data and a backlight adjusting value is transmitted in the display system 100′ so that the brightness-adjusted image data and backlight adjusting value are transmitted together, whereas the brightness-adjusted image data and the backlight adjusting value are transmitted separately in the display system 100. In the following, only differences between the display systems 100 and 100′ are described for the sake of easy explanation. (Note that the word “content” is used as a countable noun here as his word is generally used as such sometimes, for the sake of easy explanation.)

As illustrated in FIG. 6, the content providing apparatus 110′ is different from the image data providing apparatus 110 in that the content providing apparatus 110′ is provided with a content generating section (content generating means) 118 in lieu of the image transmitting section 115 and the backlight adjusting value transmitting section 117.

The content generating section 118 generates a content that contains the brightness-adjusted image data generated by the brightness adjusting section 114 and the backlight adjusting value calculated by the backlight adjusting value calculating section 116. The content generating section 118 transmits the content to the display apparatus 120′, so that the brightness-adjusted image data and the backlight adjusting value are transmitted together to the display apparatus 120′.

Moreover, the display apparatus 120′ is different from the display apparatus 120 in that the display apparatus 120′ is provided with a content acquiring section 126, an image data extracting section 127, and a backlight adjusting value extracting section 128, in lieu of the image receiving section 121 and the backlight adjusting value receiving section 123.

The content acquiring section 126 acquires the content from the content providing apparatus 110′.

The image data extracting section 127 extracts the brightness-adjusted image data from the content that the content acquiring section 126 acquired. The display device 122 displays the extracted luminance adjusting image data as it is.

The backlight adjusting value extracting section 123 extracts the backlight adjusting value from the content that the content acquiring section 126 acquired. The backlight adjusting value extracting section 123 outputs the exacted backlight adjusting value to the backlight adjusting section 124.

In this arrangement, a content (e.g., electronic book or the like) is generated from the image data and the backlight adjusting value, the image data having been adjusted in brightness, and provided to a viewer (display apparatus 120′). The viewer separates the image data and the backlight adjusting value from the content that the viewer acquired. The viewer displays the image data with its backlight controlled according to the backlight adjusting value. With this arrangement, the image data and the backlight adjusting value are handled as one content in this way. Thus, to provide the content from the content providing apparatus 110′ to the display apparatus 120′ can be easily done by distributing the content by using a recording medium such as CD, DVD, and the like, in addition to by distributing/deliver the content via a network or via broadcasting wave transmitted from a broadcasting station.

(2) Brightness Level Calculation Performed by Image Data Providing Apparatus, and Filter Determination and Brightness Adjustment Performed by Display Apparatus

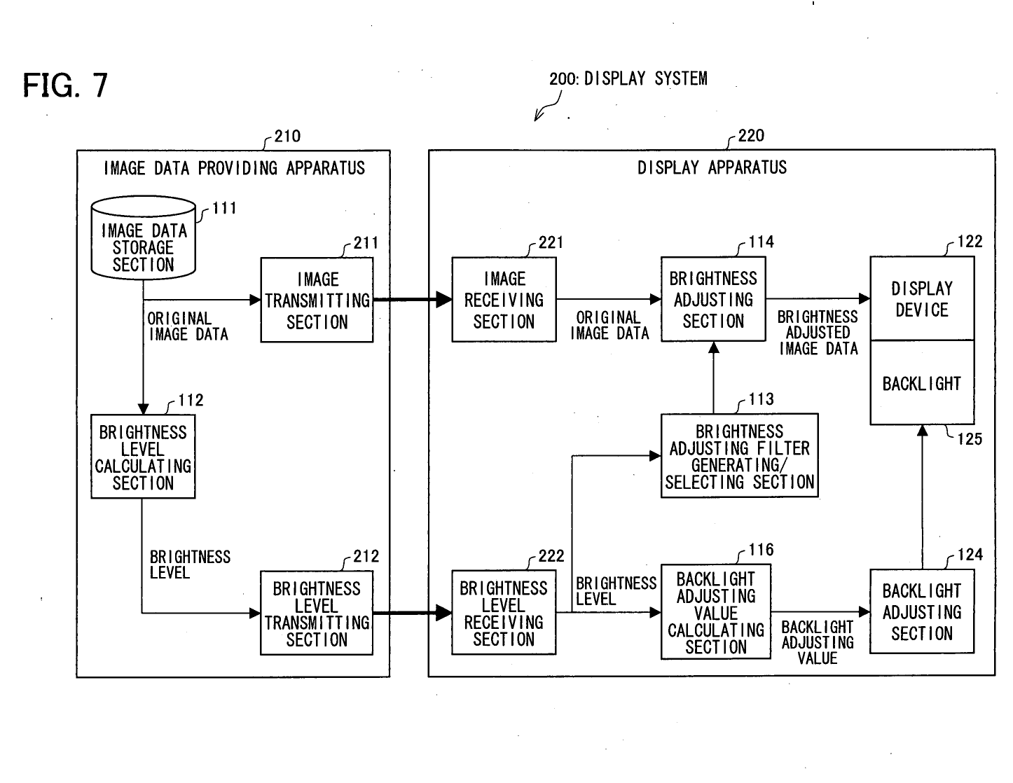

An exemplary arrangement 2 is described below describing a display system 200 referring FIG. 7, which is a functional block diagram illustrating arrangements of an image data providing apparatus 210 and a display apparatus 220 of the display system 200. Members having the like functions as corresponding members in the arrangement 1 are labeled with like references, and their explanation is omitted here.

As illustrated in FIG. 7, the display system 200 includes an image data providing apparatus 210 for transmitting image data, and a display apparatus 220 for receiving and displaying the image data. In the display system 200, the image data providing apparatus 210 performs the brightness level calculation, and the display apparatus 220 performs the filter determination and the brightness adjustment, and displays the brightness-adjusted image data. Furthermore, the display apparatus 220 calculates out a backlight adjustment value, based on the brightness level thus transmitted, and performs luminance adjustment of a backlight 125 according to the backlight adjusting value.

More specifically, the image data providing apparatus 210 and the display apparatus 220 have the following arrangements.

The image data providing apparatus 210 is provided with an image data storage section 111, a brightness level calculating section (brightness level calculating means) 112, an image transmitting section (image transmitting means) 211, and a brightness level transmitting section (brightness level transmitting means) 212.

The brightness level calculating section 122 calculates out (works out) the brightness level of original image data read out from the image data storage section 111.

The image transmitting section 211 transmits, to the display apparatus 220, the original image data read out from the image data storage section 111.

The brightness level transmitting section 212 transmits (i.e., informs), to the display apparatus 220, the brightness level calculated out by the brightness level calculating section 112.

Moreover, the display apparatus 220 is provided with a display device 122 having the backlight 125. The display apparatus 220 is further provided with an image receiving section (image receiving means) 221, a brightness level receiving section (brightness level receiving means) 222, a brightness adjusting filter generating/selecting section (brightness adjusting filter determining means) 113, a brightness adjusting section (brightness adjusting means) 114, and a backlight adjusting value calculating section (light source adjusting value calculating means) 116. Here, the brightness adjusting filter generating/selecting section 113, the brightness adjusting section 114, and the backlight adjusting value calculating section 116 are identical with the corresponding functional blocks provided to the image data providing apparatus 110 (FIG. 1).

The image receiving section 221 receives the original image data from the image data providing apparatus 210. The received original image data is displayed on the display device 122 after being adjusted in brightness by the brightness adjusting section 114.

The brightness level receiving section 222 receives (i.e., is notified of) the brightness level from the image data providing apparatus 210. The received brightness level is outputted to the brightness adjusting filter generating/selecting section 113 and the backlight adjusting value calculating section 116.

In the display system 200 with this arrangement, the image data providing apparatus 210 calculates the brightness level of the original image data and transmits it to the display apparatus 220. The display apparatus 220, which receives the brightness level from the image data providing apparatus 210, generates the brightness-adjusted image data from the original image data by increasing the brightness of the original image data according to the brightness level. The display apparatus 220 displays the brightness-adjusted image data, while controlling the backlight 125 such that the backlight 125 reduces its luminance according to how much the brightness of the brightness-adjusted image data is increased from that of the original image data.

Therefore, it is possible to realize low power consumption of the display apparatus 220 by increasing the brightness of the image data while decreasing the luminance of the backlight 125 as much as the brightness of the image data is increased. Because the calculation of the brightness level of the original image data is performed in the image data providing apparatus 210, the display apparatus 220 only need generate the brightness-adjusted image data by using the received the brightness level. That is, the display apparatus 220 does not need to perform the calculation of the brightness level.

Therefore, the display apparatus 220 can have a simple device configuration. Moreover, when the image data providing apparatus 210 can utilize a device of higher performance than can the display apparatus 220 and the image data providing apparatus 210 can generate the brightness level in advance, it is possible to take enough time to prepare the brightness level. This results in highly accurate result.

According to the display system 200, the original image data is received by the display device 122 from the image data providing apparatus 210. Therefore, the display operation will not be influenced by the lack of the brightness adjustment function and backlight adjustment function in the display apparatus (i.e., lacking the brightness level receiving section 222, brightness adjusting filter generating/selecting section 113, brightness adjusting section 114, backlight adjusting value calculating section 116, and backlight adjusting section 124). On the other hand, in the case of the display system 100 (FIG. 1), the display apparatus 120 receives the brightness-adjusted image data from the image data providing apparatus 110. Therefore, such a display device lacking the adjustment function displays the brightness-adjusted image data with high brightness.

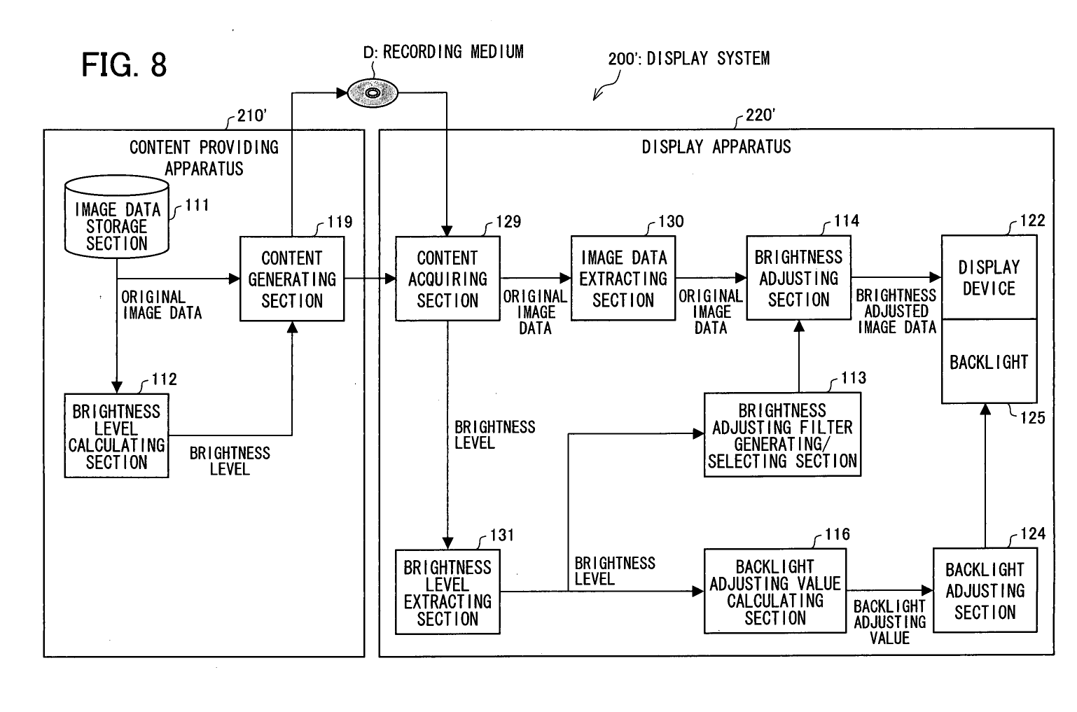

Next, a display system 200′, a modification of the arrangement 2, is described below referring to FIG. 8, which is a functional block diagram illustrating arrangements of a content providing apparatus 210′ and a display apparatus 220′ of the display system 200′.

The display system 200′ is different from the display system 200 in that a content that contains original image data and brightness level is transmitted in the display system 200′, whereas the original image data and the brightness level are transmitted separately in the display system 200 (FIG. 7). Thus, the display system 200′ has similar basic arrangement as that of the display system 200 (FIG. 7). Therefore, only the differences between the display system 200 and 200′ are described below.

As illustrated in FIG. 8, the content providing apparatus 210′ is different from the image data providing apparatus 210 in that the content providing apparatus 210′ is provided with a content generating section (content generating means) 119 in lieu of the image transmitting section 211 and the brightness level transmitting section 212.

The content generating section 119 generates a content that contains the original image data read out from an image data storage section 111 and the brightness level calculated by a brightness level calculating section 112. Then, the content generating section 119 transmits the content to the display apparatus 220′, so that the original image data and the brightness level are transmitted together.

Moreover, the display apparatus 220′ is different from the display apparatus 220 in that the display apparatus 220′ is provided with a content acquiring section (content acquiring means) 129, an image data extracting section (image data extracting means) 130, and a brightness level extracting section (brightness level extracting means) 131, in lieu of the image receiving section 221 and the brightness level receiving section 222.

The content acquiring section 129 acquires the content from the content providing apparatus 210′.

The image data extracting section 130 extracts the original image data from the content that the content acquiring section 129 acquired. The extracted original image data is displayed on the display device 122 after being adjusted in brightness by the brightness adjusting section 114.

The brightness level extracting section 131 extracts the brightness level from the content that the content acquiring section 129 acquired. The brightness level extracting section 131 outputs the extracted brightness level to the backlight adjusting value calculating section 116.

In this arrangement, a content such as a slide shows is produced from the original image data and the brightness level, and supplied to a viewer (display apparatus 220′). The viewer separates the original image data and brightness level from the content that the viewer acquired. Then, the viewer performs the filter determination, brightness adjustment, and backlight adjustment. With this arrangement, the original image data and the brightness level can be handled as one content. Thus, to provide the content from the content providing apparatus 210′ to the display apparatus 220′ can be easily done by distributing the content by using a recording medium such as CD, DVD, and the like, in addition to by distributing/deliver the content via a network, or via a broadcasting wave transmitted from a broadcasting station.

(3) Brightness Level Calculation and Filter Determination Performed by Image Date Providing Apparatus, and Brightness Adjustment Performed by Display Apparatus.

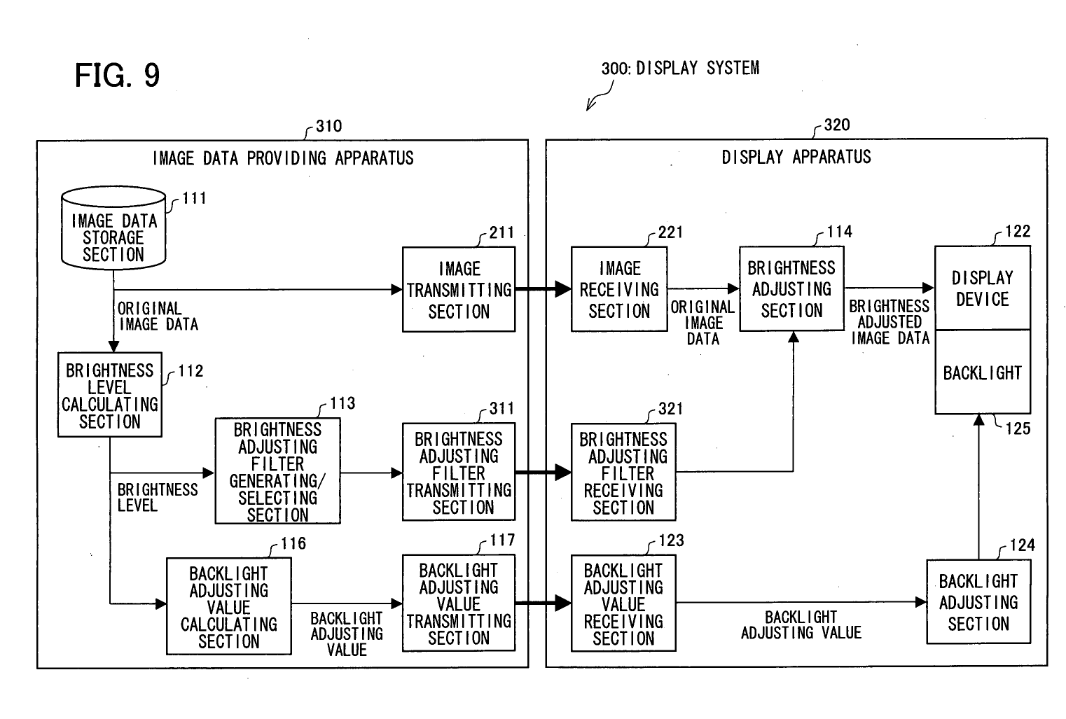

A display system 300, an arrangement 3, is described below, referring to FIG. 9, which is a functional block diagram illustrating arrangements of an image data providing apparatus 310 and a display apparatus 320 of the display system 300. Members having the like function as corresponding members in the arrangements 1 and 2 are labeled with like references, and their explanation is omitted here.

As illustrated in FIG. 9, the display system 300 includes an image data providing apparatus 310 for transmitting image data, and the display apparatus 320 for receiving and displaying the image data. In the display system 300, the image data providing apparatus 310 performs brightness level calculation and filter determination, and transmits a brightness adjusting filter to the display apparatus 320. The display apparatus 320 performs the brightness adjustment by using the brightness adjustment filter the display apparatus 320 received. Then, the display apparatus 320 displays the brightness-adjusted image data. Moreover, the display apparatus 320 performs luminance adjustment of the backlight 125, based on a backlight adjusting value transmitted thereto.

More specifically, the image data providing apparatus 310 and the display apparatus 320 have the following arrangements.

The image data providing apparatus 310 is provided with an image data storage section 111, a brightness level calculating section (brightness level calculating means) 112, a brightness adjusting filter generating/selecting section (brightness adjusting filter determining means) 113, a backlight adjusting value calculating section (light source adjusting value calculating means) 116, a backlight adjusting value transmitting section (light source adjusting value transmitting means) 117, and an image transmitting section (image transmitting means) 211. Further, the image data providing apparatus 310 is provided with a brightness adjusting filter transmitting section (brightness adjusting filter transmitting means) 311. Here, the image data storage section 111, brightness level calculating section 112, brightness adjusting filter generating/selecting section 113, backlight adjusting value calculating section 116, and the backlight adjusting value transmitting section 117 are identical with the corresponding functional blocks provided to the image data providing apparatus 110 (FIG. 1). Moreover, the image transmitting section 211 is identical with the corresponding functional block provided to the image data providing apparatus 210 (FIG. 7).

The brightness adjusting filter transmitting section 311 transmits, to the display apparatus 320, (i) the brightness adjusting filter determined (generated or selected) by the brightness adjusting filter generating/selecting section 113, or (ii) filter identification information that identifies the determined brightness adjusting filter.

Moreover, the display apparatus 320 is provided with a display device 122 including a backlight 125. Further, the display apparatus 320 is provided with a brightness adjusting filter receiving section (brightness adjusting filter receiving means) 321, in addition to an image receiving section (image receiving means) 221, brightness adjusting section (brightness adjusting means) 114, backlight adjusting value receiving section (light source adjusting value receiving means) 123, and backlight adjusting section (light source adjusting means) 124. Here, the backlight adjusting value receiving section 123 and the backlight adjusting section 124 are identical with the corresponding functional blocks provided to the display apparatus 120 (FIG. 1). Further, the image receiving section 221 and the brightness adjusting section 114 are identical with the corresponding functional blocks provided to the display apparatus 220 (FIG. 7).

The brightness adjusting filter receiving section 321 transmits, to the display apparatus 320 from the image data providing apparatus 310, (i) the determined brightness adjusting filter or (ii) the filter identification information that identifies the determined brightness adjusting filter. The brightness adjusting section 114 generates the brightness-adjusted image data by using the brightness adjusting filter that the brightness adjusting filter receiving section 321 received, or the brightness adjusting filter that is associated with the filter identification information that the brightness adjusting filter receiving section 321 received. The display apparatus 320 stores brightness adjusting filters in association with respective pieces of the filter identification information in advance.

In the display system 300 with this arrangement, the image data providing apparatus 310 calculates the brightness level of the original image data and determines the brightness adjusting filter. The image data providing apparatus 310 then transmits, to the display apparatus 320, the brightness adjusting filter thus determined or filter identification information for the brightness adjusting filter thus determined. Moreover, the image data providing apparatus 310 calculates out the backlight adjusting value that is for controlling the backlight 125 of the display apparatus 320 such that the backlight 125 reduces its luminance according to how much the brightness adjusting filter increases the brightness. The image data providing apparatus 310 transmits the backlight adjusting value to the display apparatus 320. The display apparatus 320 employs the brightness adjusting filter received from the image data providing apparatus 310 or the brightness adjusting filter (which is preferably pre-stored in the display apparatus) associated with the filter identification information thereof received from the image data providing apparatus 310, and thereby displays the brightness-adjusted image data whose brightness is increased from that of the original image data. Moreover, the display apparatus 320 controls the backlight 125 based on the backlight adjusting value received from the image data providing apparatus 310.

Thus, it is possible to realize low power consumption of the display apparatus 320 by increasing the brightness of the image data while decreasing the luminance of the backlight 125 as much as the brightness of the image data is increased. The calculation for generating or selecting the brightness-adjusted filter, and the calculation of the backlight adjusting value are performed in the image data providing apparatus 310. Because of this, the display apparatus 320 only need generate the brightness adjusted image data and control the backlight 125 by using the received brightness adjusting filter (or the filter identification information) and the backlight adjusting value. That is, the display apparatus 320 does not need to perform the calculation for generating or selecting the brightness adjusting filter, the calculation of the backlight adjusting value, and the calculation of the backlight adjusting value for controlling the backlight 125 of the display apparatus 320 such that the backlight 125 reduces its luminance according to how much the brightness of the brightness-adjusted image data is increased from that of the original image data.

Thus, the display apparatus 320 can have a simple device configuration. Moreover, the when the image data providing apparatus 310 can utilize a device of a higher performance than can the display apparatus 320 and the image data providing apparatus 310 can prepare the brightness adjusting filter (or filter identification information) and the backlight adjusting value in advance, it is possible to take enough time to prepare brightness adjusting filter (or filter identification information) and the backlight adjusting value. Thus, it is possible to attain highly accurate result.

According to the display system 300, the original image data is received by the display device 122 from the image data providing apparatus 310. Therefore, the display operation will not be influenced by the lack of the brightness adjustment function and backlight adjustment function in the display device (i.e., lacking the brightness adjusting filter receiving section 321, brightness adjusting section 114, backlight adjusting value receiving section 123, and backlight adjusting section 124). On the other hand, in the case of the display system 100 (FIG. 1), the display apparatus 120 receives the brightness-adjusted image data from the image data providing apparatus 110. Therefore, such a display device lacking the adjustment function displays the brightness-adjusted image data with high brightness.

[Brightness Level]

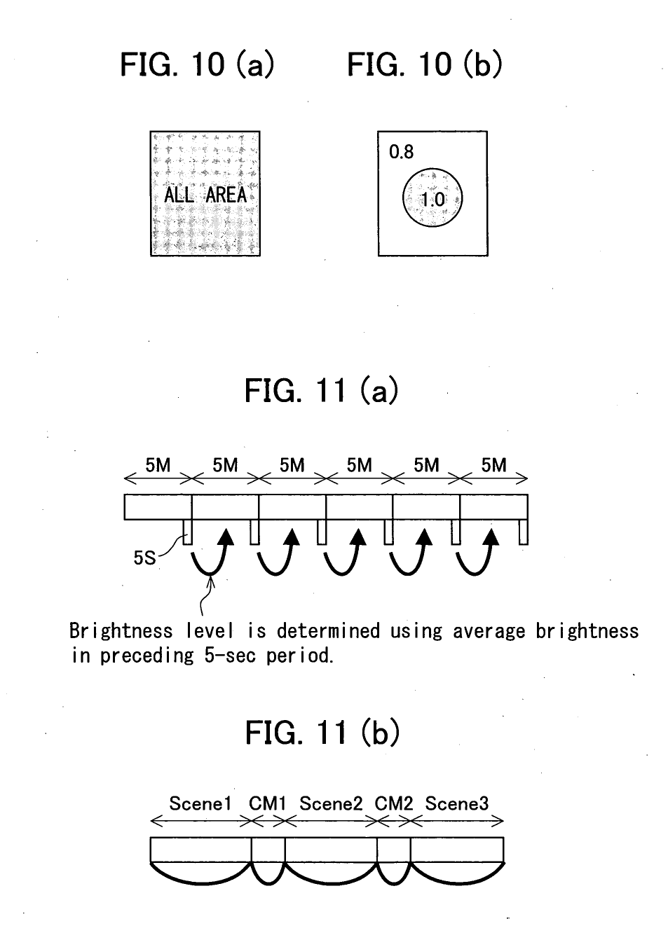

Referring to FIGS. 10 and 11, the brightness level in the present invention is described below.

The brightness level of the image data is determined either (1) spatially or (2) temporally.

(1) Spatial Determination

A brightness level of still image data is determined by averaging brightness of each pixel in a whole region (FIG. 10(a)) of an image of the still image data. Specifically, for example, the brightness of each pixel is calculated from RGB values of each pixel in the whole region. Then, an average of brightness of each pixel is calculated out as the brightness level of the still image data. The higher the RGB values the higher brightness level, meanwhile the lower RGB values the lower brightness level.

Moreover, pixels may be weighted according to their positions in the region. For example as illustrated in FIG. 10(b), pixels in a central portion may have weight of 1.0, and pixels in peripheral portion may have weight of 0.8. Then, an average of weighted brightness is calculated out as the brightness level of the still image data. Based on such a concept that the central portion has important information but the peripheral portion has little important information, the central portion is weighted more than the peripheral portion. The weighting can be arbitrary and is not limited to two weight stages such as 1.0 and 0.8 as in the case illustrated in FIG. 10(b). That is, the weighting may be multi-staged based on distances from the center of the image such that the pixels farer from the center has less weight.

Here, the case of the still image data is explained. Dynamic image data may be regarded as a set of plural still image data. Thus, the still image data constituting the dynamic image data may be treated as in FIG. 10(a) or FIG. 10(b). The spatial determination of the brightness level may be carried out for dynamic image data in this way.

The spatial determination of the brightness level for dynamic image data may be performed for all frames (all still image data) constituting the dynamic image data, or for some of all the frames (e.g., still image data of two frames per one second are treated as above).

(2) Temporal Determination

Here, the other determination method than the spatial determination, that is, the temporal determination of the brightness level of dynamic image data is described.

For example, a case of 30-minute dynamic image data as illustrated in FIG. 11(a) is discussed here. For example, the dynamic image data is sectioned per 5 min. An average of brightness of last 5 seconds in a preceding period is calculated as a brightness level of a period following the preceding period. Note that the length of the periods into which the dynamic image data is sectioned, and the length of time from which the average is calculated out may be any length. In the case of FIG. 11(a), the average of the brightness of the preceding period is regarded as the period following the preceding period. This arrangement is suitable for contents having real-time property (e.g., contents that are displayed upon reception thereof), such as broadcast contents.

Moreover, as illustrated in FIG. 11(b), an average of brightness may be calculated out per scene (period) as the brightness level of the scene. In FIG. 11(b), the dynamic image data is divided into scenes and CMs (commercials). The brightness levels are worked out for every scene and CM. In case of FIG. 11(b), an average of brightness in a scene is regarded as the brightness level of the scene. Thus, this arrangement is not applicable to the contents having real-time property, but is suitable for stored contents and the like having not real-time property (e.g., contents that are displayed not immediately after the reception thereof).

How to device the dynamic image data is not limited to the case of FIG. 11(b) in which the dynamic image data is divided according to CMs. For example, the dynamic image data may be divided (i) according to large changes in brightness, (ii) according to large changes in averages of brightness between scenes, (iii) per program, (iv) according to kinds of the contents (sports, dramas, movies, etc.), or (v) the like.

[Brightness Adjustment]

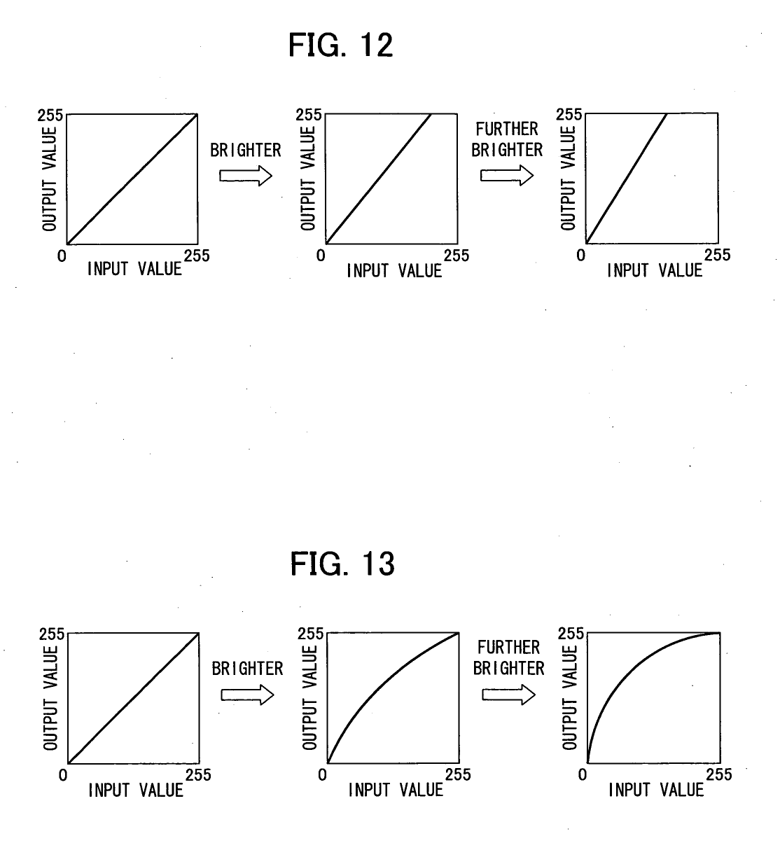

Referring to FIGS. 12 and 13, the brightness adjustment of the present invention is described below.

The brightness adjusting filter for the brightness adjustment in the present invention is not particularly limited. Specifically, the brightness adjusting filter may be a linear function as illustrated in FIG. 12, a gamma curve as illustrated in FIG. 13, or stepwise function.

In general, the image becomes brighter when the RGB values of the image data are increased in the same ratios. So, eyes of the user senses the same brightness if the backlight reduces its luminance as much as the image becomes brighter. The present invention utilizes this phenomenon, thereby to attain lower power consumption. However, if the image data is corrected excessively as illustrated in FIG. 12, portions that are originally bright become totally white (white spots), whereby the image becomes an image with no or less contrast.

FIG. 13 is an explanatory view illustrating the brightness adjustment based on a gamma curve. The brightness will not be saturated when the gamma curve is used (the decline of the curve becomes is sharper for a larger γ). Thus, the brightness can be increased with a contrast to some extent. However, the brightness of the whole image limits the extent of the correction of the image in its brightness. Thus, if a originally-bright image was corrected to be brighter, the image would be whitened as a whole, as in the case of FIG. 12.

[Data Structure of Parameter]

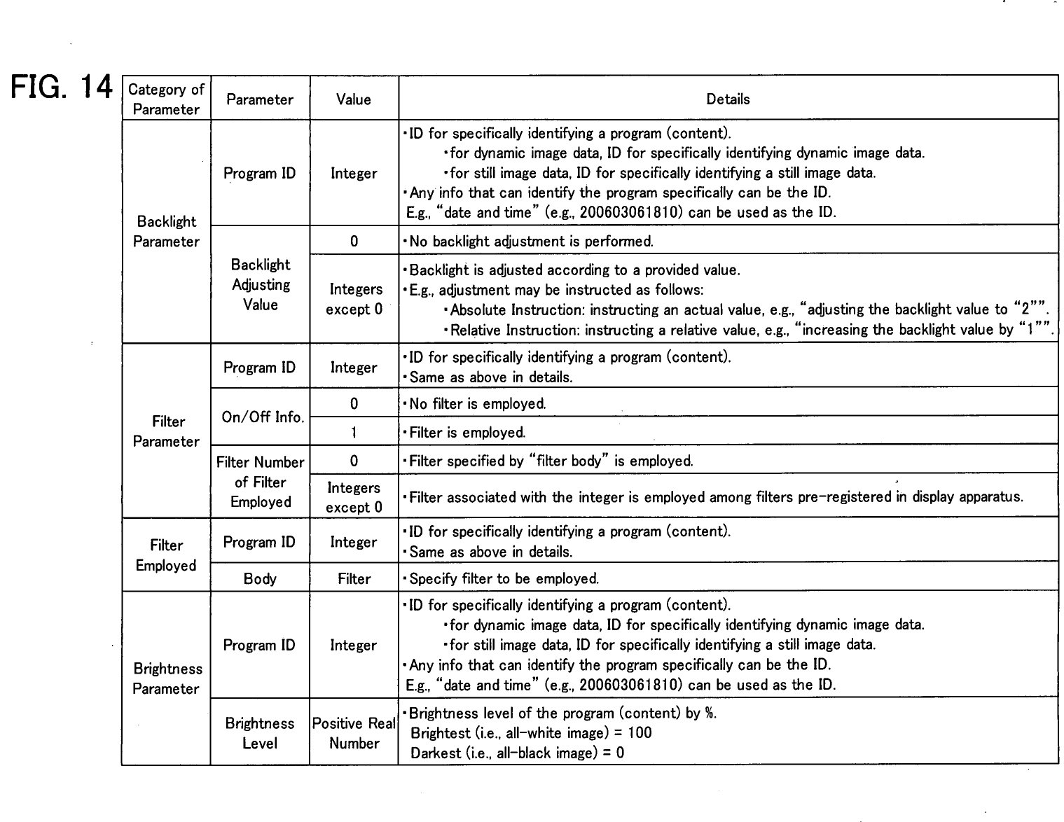

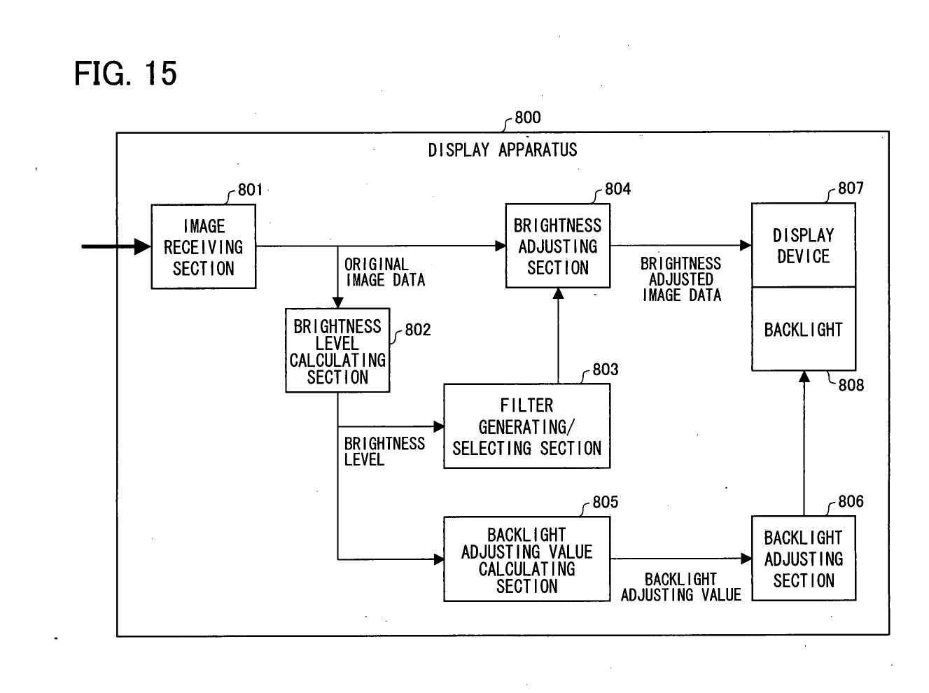

Referring to FIG. 14, the exemplary parameters used in the present invention is described below.

As illustrated in FIG. 14, the categories of the parameters are as follows: backlight parameter, filter parameter, filter employed, and brightness parameter.

The backlight parameter contains “program ID” and “backlight adjusting value”. The program ID is an ID that specifically identifies the program (content). The backlight adjusting value indicates the adjusting value of the backlight.

The filter parameter contains “program ID”, “On/Off information”, “filter number of filter employed”. The program ID is an ID that specifically identifies the program (content). The On/Off information indicates whether to employ the filter or not. The filter number of filter employed indicates the filter to be employed.

The filter employed contains “program ID” and “Body”. The program ID is an ID that specifically identifies the program (content). The body is data of the filter.

The brightness parameter contains “program ID” and “brightness level”. The program ID is an ID that specifically identifies the program (content). The brightness level describes the brightness of the program (content) by percentage.

Here, the display systems 100, 100′, and 300 (FIGS. 1, 6, and 9), the backlight adjusting value is transmitted as the “backlight parameter”. In the display system 200 and 200′ (FIGS. 7 and 8), the brightness level is transmitted as the “brightness parameter”. In the display system 300 (FIG. 9), the filter is transmitted as “filter parameter” or “filter employed”.

Described above is a case where the parameters categorized into four categories are transmitted separately, e.g., as “backlight parameter”, “filter parameter”, “brightness parameter”, and “filter employed”. However, some or all of these parameters may be transmitted in combination. In this case, only one piece of “program ID” may be transmitted to be used commonly for the parameters transmitted in combination. Note that the values exemplified in FIG. 14 are merely examples and are not to limit the present invention.

[Synchronization of Image Data and Parameter]

As described in [Data Structure of Parameters], it is possible to synchronize the parameters and the image data by using “program ID” of each parameter category.

How to acquire a parameter is described below.

(1) Parameter Acquisition with Synchronization

The parameter may be transmitted by inserting in the image data. For example, the parameter may be inserted (i) in a period between data and data, (ii) in a data region in MPRG (Moving Pictures Experts Group), or (iii) the like. Moreover, the parameter information may be transmitted via a data communication path that is exclusively used for data transmission.

(2) Parameter Acquisition with No Synchronization

The parameter may be inserted in EPG (Electronic Program Guide). In this case, all the parameters explained in [Data Structure of Parameters] may be inserted, or only such IDs that identify the parameter categories may be transmitted without transmitting the parameters. In the latter case, the parameter categories are extracted from the IDs inserted in the EPG, referring to the associations therebetween.

The filter to use may be transmitted separately, i.e., not by inserting the filter in the EPG. In this case, the filter can be extracted referring to the program ID contained in the parameter category, even if the filter is transmitted separately.

Moreover, the parameter may be acquired via a network.

For instance, a data having a large data size, (such as a filter) may be supplied to the display apparatus at a request from the display apparatus, instead of providing the whole set of the data in advance. For example, the display apparatus transmits, to the providing apparatus, an ID (e.g., filter number of the filter to use) that identifies the filter to acquire. The providing apparatus transmits, to the display apparatus, a filter that is in association with the ID transmitted thereto. With this, it is possible to acquire the necessary filter only when it is necessary. This avoids unnecessary data transmission.

The display apparatus may cache a filter that the display apparatus once received. In this case, the display apparatus checks whether the filter to use is cached therein, and if yes, the display apparatus uses the filter cached therein. If not, the display apparatus transmits, to the providing apparatus, an ID that identifies the filter to acquire, and acquires the filter from the providing apparatus. The acquired filter is then cached. The present invention may be arranged such that if there is no space for caching, the acquired filter is not cached, or that a cached filter that has not been reused for a given period of time is deleted.

[Miscellaneous]

(1) The display apparatus of the present invention is applicable to a portable telephone having a liquid crystal panel thereby having a television receiving function, but is not limited thereto. That is, the display apparatus of the present invention is applicable to any display apparatus having a light source (such as a backlight, a frontlight or the like) for illuminating a display screen from front or back of the display screen. Further, the display apparatus of the present invention may be a display apparatus integrated with functions of an information apparatus (typically, a personal computer).

An typical example of the light source of the display apparatus is a backlight having plural lamps (e.g., fluorescent lamps) and being provided in the rear of the display screen. Needless to say, a frontlight for use in reflective liquid crystal display apparatuses may be applied.

(2) The parameters to be transmitted from the image data providing apparatus to the display apparatus may be commonly used regardless of which type of the light source is provided to the display apparatus, or may be different depending on which type of the light source is provided to the display apparatus. (That is, common parameters may be used regardless of whether a backlight or a frontlight is provided to the display apparatus, or different parameters may be used depending on whether a backlight or a frontlight is provided to the display apparatus.)

In case where the common parameters are used regardless of which type of the light source is provided to the display apparatus, the display apparatus may control the light source (backlight, frontlight, or the like) in the same manner regardless of which type of the light source is provided to the display apparatus, or in different manners depending on which type of the light source is provided to the display apparatus. Further, in case where the light source is controlled in different manners depending on which type of the light source is provided to the display apparatus, the light source may be controlled according to the received parameters that is corrected to be suitable for the light source. (3) In general, the display apparatus provided with the display device performs filter process in order to compensate display characteristics (color tint and the like) of the display device. In the display apparatuses (FIGS. 7 to 9) of the present invention, it is possible to perform the brightness adjustment filter process together with the filter process for compensating the display characteristics. In these filter processes are performed together, there will be substantially no increase in processing time even thought the brightness adjusting filter process is added.

(4) The brightness adjustment of the image data in the present invention is realized as the filter process by applying gamma correction or the like. This makes it possible to express contrast regarding an object shown in the image. Further, because according to the present invention, the brightness of the object is adjusted to be appropriate, it is possible to avoid deterioration of image quality.

(5) In case where the display system of the present invention is applied to broadcasting, that is, in case where the image data providing apparatus transmits a broadcasting content, it is possible to arrange such that a broadcasting station performs the calculation of the brightness level and brightness adjustment and broadcasts the brightness level and brightness-adjusted image data. In this case, the display apparatus is a broadcasting receiver and displays the brightness-adjusted image data and controls luminance of the light source (e.g., backlight).

In case where the display system of the present invention is applied to production of DVD or the like, that is, in case where the content providing apparatus prepares a content to be written on a DVD or the like, a manufacturing company such as a publishing company may perform the calculation of the brightness level and brightness adjustment, and produce the content that contains the brightness level and the brightness-adjusted image data, and write the content on the DVD or the like. In this case, the display apparatus as a content reproducing apparatus displays the brightness-adjusted image data and controls the luminance of the light source (e.g., backlight).

In image data providing apparatus (content providing apparatus) of the broadcasting company or the publishing company, it is possible to perform the data process with sufficient resources. Thus, it is possible to highly appropriate results even in highly sophisticated calculation necessary for the calculation of the brightness level and the brightness adjustment. On the other hand, the display apparatus does not need to perform such sophisticated calculation. This allows the display apparatus to be simplified in its device configuration, thereby attaining miniaturization, and further low power consumption and high-speed performance due to the elimination of the brightness calculation etc. from its task.

Note that, the blocks of the image data providing apparatuses 110, 210, and 310, the display apparatuses 120, 120′, 220, 220′, and 320, and the content providing apparatuses 110′ and 210′ may be realized by way of hardware or software as executed by a CPU as follows. Especially, the brightness level calculating section 112, brightness adjusting filter generating/selecting section 113, brightness adjusting section 114, image transmitting section 115, backlight adjusting value calculating section 116, backlight adjusting value transmitting section 117, content generating section 118, content generating section 119, image receiving section 121, backlight adjusting value receiving section 123, backlight adjusting section 124, content acquiring section 129, image data extracting section 130, brightness level extracting section 131, image transmitting section 211, brightness level transmitting section 212, image receiving section 221, brightness level receiving section 222, brightness adjusting filter transmitting section 311, and brightness adjusting filter receiving section 321 may be realized by way of hardware or software as executed by a CPU as follows.

The image data providing apparatuses 110 and the like, the display apparatuses 120 and the like, and the content providing apparatuses 110′ and the like each include a CPU (central processing unit) and memory devices (memory media). The CPU executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to the image data providing apparatus 110 or the like, the display apparatus 120 or the like, or the content providing apparatus 110′ or the like, a computer-readable storage medium containing control program code (executable program, intermediate code program, or source program) for the image data providing apparatus 110 or the like, the display apparatus 120 or the like, or the content providing apparatus 110′ or the like, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The image data providing apparatuses 110 and the like, the display apparatuses 120 and the like, and the content providing apparatuses 110′ and the like may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth (Registered Trademark), 802.11 wireless, HDR, mobile telephone network, satellite line, or terrestrial digital network. The present invention encompasses a carrier wave or data signal transmission in which the program code is embodied electronically.

An image data providing apparatus according to the present invention is for providing, to a display apparatus including a light source for illuminating a display screen from at least either of front and rear of the display screen, image data that is to be displayed on the display apparatus. The image data providing apparatus according to the present invention is arranged to include:

brightness level calculating means for calculating a brightness level, which is a property regarding brightness of original image data;

brightness adjusting means for generating brightness-adjusted image data from the original image data by increasing the brightness of the original image data according to the brightness level calculated by the brightness level calculating means; and

image transmitting means for transmitting, to the display apparatus, the brightness-adjusted image data generated by the brightness adjusting means.

A method according to the present invention is for controlling an image data providing apparatus for providing, to a display apparatus including a light source for illuminating a display screen from at least either of front and rear of the display screen, image data that is to be displayed on the display apparatus. The method according to the present invention is arranged to include:

(a) calculating a brightness level, which is a property regarding brightness of original image data;

(b) generating brightness-adjusted image data from the original image data by increasing the brightness of the original image data according to the brightness level calculated in the step (a); and

(c) transmitting, to the display apparatus, the brightness-adjusted image data generated in the step (b).

Here, the light source of the display apparatus is only required to be able to illuminate the display screen from either of front or rear of the display screen. For example, the light source may be a backlight or a frontlight.

A display apparatus according to the present invention includes a light source. The display apparatus according to the present invention is arranged to include:

image receiving means for receiving brightness-adjusted image data from an image data providing apparatus; and

light source-adjusting means for controlling the light source such that the light source reduces its luminance according to how much brightness of the brightness-adjusted image data is increased from the brightness of the original image data.

A method according to the present invention is for controlling a display apparatus including a light source for illuminating a display screen from at least either of front and rear of the display screen. The method according to the present invention is arranged to include:

receiving brightness-adjusted image data from an image data providing apparatus; and

controlling the light source such that the light source reduces its luminance according to how much brightness of the brightness-adjusted image data is increased from brightness of original image data.

In this arrangement, the image data providing apparatus calculates the brightness level of the original image data and generates the brightness-adjusted image data form the original image data by increasing the brightness of the original image data. Then, the image data providing apparatus transmits the brightness-adjusted image data to the display apparatus. Then, the display apparatus receives the brightness-adjusted image data from the image data providing apparatus and display it thereon, while controlling the light source thereof such that the luminance of the light source is reduced according to how much the brightness of the brightness-adjusted image data is increased from that of the original image data. Here, the light source of the display apparatus is only required to be able to illuminate the display screen from either of front or rear of the display screen. For example, the light source may be a backlight or a frontlight.

With this arrangement, it is possible to attain low power consumption of the display apparatus by increasing the brightness of the image data and decreasing the luminance of the light source as much as the brightness of the image data is increased. Because the calculation of the brightness level of the original image data and the generation of the brightness adjusting image data are performed in the image data providing apparatus, the display apparatus can display the received brightness-adjusted image data as it is. That is, the display apparatus does not need to perform the calculation of the brightness adjustment.

Therefore, the display apparatus can have a simple device configuration. Moreover, when the image data providing apparatus can utilize a device of higher performance than can the display apparatus and the image data providing apparatus can generate the brightness-adjusted image data in advance, it is possible to take enough time for preparing the brightness-adjusted image data. This results in better brightness adjustment.

Furthermore, the image data providing apparatus according to the present invention may include:

light source adjusting value calculating means for calculating a light source adjusting value used for controlling the light source of the display apparatus such that the light source reduces its luminance according to how much the brightness adjusting means increases the brightness of the original image data; and

light source adjusting value transmitting means for transmitting, to the display apparatus, the light source adjusting value calculated by the light source adjusting value calculating means.

Further, the display apparatus according to the present invention may include:

light source adjusting value receiving means for receiving a light source adjusting value from the image data providing apparatus,

the light source-adjusting means controlling the light source according to the light source adjusting value received by the light source adjusting value receiving means.

In this arrangement, the image data providing apparatus calculates out the light source adjusting value for controlling the light source of the display apparatus such that the light source reduces its luminance according to how much the brightness adjusting means increases the brightness of the original image data, and transmits the light source adjusting value to the display apparatus. The display apparatus, which receives the light source adjusting value from the image data providing apparatus, controls the light source based on the light source adjusting value.

Thus, the calculation of the light source adjusting value is performed in the image data providing apparatus. The display apparatus can control the light source based on the received light source adjusting value as it is. That is, the display apparatus does not need to calculate the light source adjusting value for decreasing the luminance of the light source of the display apparatus according to how much the brightness is increased from that of the original image data.

Therefore, the display apparatus can have a simple device configuration. Moreover, when the image data providing apparatus can utilize a device of higher performance than can the display apparatus and the image data providing apparatus can generate the light source adjusting value in advance, it is possible to take enough time for preparing the light source adjusting value. This results in highly accurate result.

An image data providing apparatus according to the present invention is for providing, to a display apparatus including a light source for illuminating a display screen from at least either of front and rear of the display screen, image data that is to be displayed on the display apparatus. The image data providing apparatus according to the present invention is arranged to include:

brightness level calculating means for calculating a brightness level, which is a property regarding brightness of original image data; and

brightness level transmitting means for transmitting, to the display apparatus, the brightness level calculated by the brightness level calculating means.

A method according to the present invention is for controlling an image data providing apparatus for providing, to a display apparatus including a light source for illuminating a display screen from at least either of front and rear of the display screen, image data that is to be displayed on the display apparatus. The method according to the present invention is arranged to include:

(a) calculating a brightness level, which is a property regarding brightness of original image data; and

(b) transmitting, to the display apparatus, the brightness level calculated in the step (a).

A display apparatus according to the present invention includes a light source for illuminating a display screen from at least either of front and rear of the display screen. The display apparatus according to the present invention is arranged to include:

brightness level receiving means for receiving, from an image data providing apparatus, a brightness level, which is a property regarding brightness of original image data;

brightness adjusting means for generating brightness-adjusted image data from the original image data by increasing the brightness of the original image data according to the brightness level received by the brightness level receiving means; and

light source adjusting means for controlling the light source such that the light source reduces its luminance according to how much the brightness adjusting means increases the brightness of the original image data.

A method according to the present invention is for controlling a display apparatus including a light source for illuminating a display screen from at least either of front and rear of the display screen. The method according to the present invention is arranged to include:

(a) receiving, from an image data providing apparatus, a brightness level, which is a property regarding brightness of original image data;

(b) generating brightness-adjusted image data from the original image data by increasing the brightness of the original image data according to the brightness level received in the step (a); and

(c) controlling the light source such that the light source reduces its luminance according to how much brightness of the brightness-adjusted image data is increased from brightness of original image data in the step (a).

In this arrangement, the image data providing apparatus calculates the brightness level of the original image data and transmits it to the display apparatus. The display apparatus, which receives the brightness level from the image data providing apparatus, generates the brightness-adjusted image data from the original image data by increasing the brightness of the original image data according to the brightness level. The display apparatus displays the brightness-adjusted image data, while controlling the light source such that the light source reduces its luminance according to how much the brightness of the brightness-adjusted image data is increased from that of the original image data. Here, the light source of the display apparatus is only required to be able to illuminate the display screen from either of front or rear of the display screen. For example, the light source may be a backlight or a frontlight.

Therefore, it is possible to realize low power consumption of the display apparatus by increasing the brightness of the image data while decreasing the luminance of the light source as much as the brightness of the image data is increased. Because the calculation of the brightness level of the original image data is performed in the image data providing apparatus, the display apparatus only need generate the brightness-adjusted image data by using the received the brightness level. That is, the display apparatus does not need to perform the calculation of the brightness level.

Therefore, the display apparatus can have a simple device configuration. Moreover, when the image data providing apparatus can utilize a device of higher performance than can the display apparatus and the image data providing apparatus can generate the brightness level in advance, it is possible to take enough time to prepare the brightness level. This results in highly accurate result.

Further, the image data providing apparatus according to the present invention may include:

image transmitting means for transmitting the original image data to the display apparatus.

Further, the display apparatus according to the present invention may include:

image receiving means for receiving the original image data from the image data providing apparatus.

In this arrangement, the original image data is transmitted from the image data providing apparatus to the display apparatus.

With this arrangement, the display apparatus can generate the brightness-adjusted image data from the original image data and brightness level thus received. Moreover, because the display apparatus receives the original image data that has not been adjusted in brightness, there will no influence on the display operation even if the display apparatus does not have the brightness adjustment function and the light source adjustment function.

An image data providing apparatus according to the present invention is for providing, to a display apparatus including a light source for illuminating a display screen from at least either of front and rear of the display screen, image data that is to be displayed on the display apparatus. The image data providing apparatus is arranged to include:

brightness level calculating means for calculating a brightness level, which is a property regarding brightness of original image data;

brightness adjusting filter determining means for determining a brightness adjusting filter, based on the brightness level calculated by the brightness level calculating means;

brightness adjusting filter transmitting means for transmitting, to the display apparatus, (i) the brightness adjusting filter determined by the brightness adjusting filter determining means, or (ii) filter identification information that identifies the brightness adjusting filter determined by the brightness adjusting filter determining means;

light source adjusting value calculating means for calculating a light source adjusting value used for controlling the light source of the display apparatus such that the light source reduces its luminance according to how much the brightness adjusting filter determined by the brightness adjusting filter determining means increases brightness; and

light source adjusting value transmitting means for transmitting, to the display apparatus, the light source adjusting value calculated by the light source adjusting value calculating means.

A method according to the present invention is for controlling an image data providing apparatus for providing, to a display apparatus including a light source for illuminating a display screen from at least either of front and rear of the display screen, image data that is to be displayed on the display apparatus. The method according to the present invention is arranged to include:

(a) calculating a brightness level, which is a property regarding brightness of original image data;

(b) determining a brightness adjusting filter, based on the brightness level calculated in the step (a);

(c) transmitting, to the display apparatus, the brightness adjusting filter determined in the step (b), or filter identification information that identifies the brightness adjusting filter determined in the step (b);

(d) calculating a light source adjusting value used for controlling the light source of the display apparatus such that the light source reduces its luminance according to how much the brightness adjusting filter determined in the step (b) increases brightness; and

(e) transmitting, to the display apparatus, the light source adjusting value calculated in the step (d).

A display apparatus according to the present invention includes a light source for illuminating a display screen from at least either of front and rear of the display screen. The display apparatus according to the present invention is arranged to include:

brightness adjusting filter receiving means for receiving, from an image data providing apparatus, a brightness adjusting filter or filter identification information that identifies the brightness adjusting filter;

brightness adjusting means for generating brightness-adjusted image data from original image data by increasing brightness of the original image data by applying (i) the brightness adjusting filter received by the brightness adjusting filter receiving means or (ii) the brightness adjusting filter associated with the filter identification information received by the brightness adjusting filter receiving means;

light source adjusting value receiving means for receiving a light source adjusting value from the image data providing apparatus; and

light source-adjusting means for controlling the light source according to the light source adjusting value received by the light source adjusting value receiving means.

A method according to the present invention is for controlling a display apparatus including a light source for illuminating a display screen from at least either of front and rear of the display screen. The method according to the present invention is arranged to include:

(a) receiving, from an image data providing apparatus, a brightness adjusting filter or filter identification information that identifies the brightness adjusting filter;

(b) generating brightness-adjusted image data from original image data by increasing brightness of the original image data by applying (i) the brightness adjusting filter received in the step (a) or (ii) the brightness adjusting filter associated with the filter identification information received in the step (a);

(c) receiving a light source adjusting value from the image data providing apparatus; and

(d) controlling the light source according to the light source adjusting value received in the step (c).

In this arrangement, the image data providing apparatus calculates the brightness level of the original image data and determines the brightness adjusting filter. The image data providing apparatus then transmits, to the display apparatus, the brightness adjusting filter thus determined or filter identification information for the brightness adjusting filter thus determined. Moreover, the image data providing apparatus calculates out the light source adjusting value that is for controlling the light source of the display apparatus such that the light source reduces its luminance according to how much the brightness adjusting filter increases the brightness. The image data providing apparatus transmits the light source adjusting value to the display apparatus. The display apparatus employs the brightness adjusting filter received from the image data providing apparatus or the brightness adjusting filter associated with the filter identification information thereof received from the image data providing apparatus (in this case, brightness adjusting filters are pre-stored in the display apparatus in association with respective pieces of filter identification information), and thereby displays the brightness-adjusted image data whose brightness is increased from that of the original image data. Moreover, the display apparatus controls the light source based on the light source adjusting value received from the image data providing apparatus.

Thus, it is possible to realize low power consumption of the display apparatus by increasing the brightness of the image data while decreasing the luminance of the light source as much as the brightness of the image data is increased. The calculation for generating or selecting the brightness-adjusted filter, and the calculation of the light source adjusting value are performed in the image data providing apparatus. Because of this, the display apparatus only need generate the brightness adjusted image data and control the light source by using the received brightness adjusting filter (or the filter identification information) and the light source adjusting value. That is, the display apparatus does not need to perform the calculation for generating or selecting the brightness adjusting filter, the calculation of the light source adjusting value, and the calculation of the light source adjusting value for controlling the light source of the display apparatus such that the light source reduces its luminance according to how much the brightness of the brightness-adjusted image data is increased from that of the original image data.

Thus, the display apparatus can have a simple device configuration. Moreover, the when the image data providing apparatus can utilize a device of a higher performance than can the display apparatus and the image data providing apparatus can prepare the brightness adjusting filter (or filter identification information) and the light source adjusting value in advance, it is possible to take enough time to prepare brightness adjusting filter (or filter identification information) and the light source adjusting value. Thus, it is possible to attain highly accurate result.

Further, the image data providing apparatus according to the present invention may include:

image transmitting means for transmitting the original image data to the display apparatus.

Furthermore, a display apparatus according to the present invention may include:

image receiving means for receiving the original image data from the image data providing apparatus.

In this arrangement, the original image data is transmitted from the image data providing apparatus to the display apparatus.

Thus, the display apparatus can generate the brightness-adjusted image data and control the light source by using the received original image data and the brightness-adjusted filter (or filter identification information) and the light source adjusting value. Moreover, because the display apparatus receives the original image data that has not been adjusted in brightness, there will no influence on the display operation even if the display apparatus does not have the brightness adjustment function and the light source adjustment function.

Furthermore, the image data providing apparatus and the display apparatus may be realized by using a computer. In this case, the scope of the present invention encompasses control programs for controlling a computer to function as the respective means, thereby realizing the image data providing apparatus and the display apparatus by using the computer, and computer-readable recording medium storing the same.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An image data providing apparatus for providing, to a display apparatus including a light source for illuminating a display screen from at least either of front and rear of the display screen, image data that is to be displayed on the display apparatus, the image data providing apparatus comprising:
brightness level calculating means for calculating a brightness level, which is a property regarding brightness of original image data;
brightness adjusting means for generating brightness-adjusted image data from the original image data by increasing the brightness of the original image data according to the brightness level calculated by the brightness level calculating means; and
image transmitting means for transmitting, to the display apparatus, the brightness-adjusted image data generated by the brightness adjusting means.

2. An image data providing apparatus as set forth in claim 1, comprising:
light source adjusting value calculating means for calculating a light source adjusting value used for controlling the light source of the display apparatus such that the light source reduces its luminance according to how much the brightness adjusting means increases the brightness of the original image data; and
light source adjusting value transmitting means for transmitting, to the display apparatus, the light source adjusting value calculated by the light source adjusting value calculating means.

3. A display apparatus including a light source for illuminating a display screen from at least either of front and rear of the display screen, the display apparatus comprising:
image receiving means for receiving brightness-adjusted image data from an image data providing apparatus; and
light source-adjusting means for controlling the light source such that the light source reduces its luminance according to how much brightness of the brightness-adjusted image data is increased from the brightness of the original image data.

4. A display apparatus as set forth in claim 3, comprising:
light source adjusting value receiving means for receiving a light source adjusting value from the image data providing apparatus,
the light source-adjusting means controlling the light source according to the light source adjusting value received by the light source adjusting value receiving means.

5. A method for controlling an image data providing apparatus for providing, to a display apparatus including a light source for illuminating a display screen from at least either of front and rear of the display screen, image data that is to be displayed on the display apparatus, the method comprising:
(a) calculating a brightness level, which is a property regarding brightness of original image data;
(b) generating brightness-adjusted image data from the original image data by increasing the brightness of the original image data according to the brightness level calculated in the step (a); and
(c) transmitting, to the display apparatus, the brightness-adjusted image data generated in the step (b).

6. A method for controlling a display apparatus including a light source for illuminating a display screen from at least either of front and rear of the display screen, the method comprising:
receiving brightness-adjusted image data from an image data providing apparatus; and
controlling the light source such that the light source reduces its luminance according to how much brightness of the brightness-adjusted image data is increased from brightness of original image data.

7. An image data providing apparatus for providing, to a display apparatus including a light source for illuminating a display screen from at least either of front and rear of the display screen, image data that is to be displayed on the display apparatus, the image data providing apparatus comprising:
brightness level calculating means for calculating a brightness level, which is a property regarding brightness of original image data; and
brightness level transmitting means for transmitting, to the display apparatus, the brightness level calculated by the brightness level calculating means.

8. An image data providing apparatus as set forth in claim 7, comprising:
image transmitting means for transmitting the original image data to the display apparatus.

9. A display apparatus including a light source for illuminating a display screen from at least either of front and rear of the display screen, the display apparatus comprising:
brightness level receiving means for receiving, from an image data providing apparatus, a brightness level, which is a property regarding brightness of original image data;
brightness adjusting means for generating brightness-adjusted image data from the original image data by increasing the brightness of the original image data according to the brightness level received by the brightness level receiving means; and
light source adjusting means for controlling the light source such that the light source reduces its luminance according to how much the brightness adjusting means increases the brightness of the original image data.

10. A display apparatus as set forth in claim 9, comprising:
image receiving means for receiving the original image data from the image data providing apparatus.

11. A method for controlling an image data providing apparatus for providing, to a display apparatus including a light source for illuminating a display screen from at least either of front and rear of the display screen, image data that is to be displayed on the display apparatus, the method comprising:
(a) calculating a brightness level, which is a property regarding brightness of original image data; and
(b) transmitting, to the display apparatus, the brightness level calculated in the step (a).

12. A method for controlling a display apparatus including a light source for illuminating a display screen from at least either of front and rear of the display screen, the method comprising:
(a) receiving, from an image data providing apparatus, a brightness level, which is a property regarding brightness of original image data;
(b) generating brightness-adjusted image data from the original image data by increasing the brightness of the original image data according to the brightness level received in the step (a); and
(c) controlling the light source such that the light source reduces its luminance according to how much brightness of the brightness-adjusted image data is increased from brightness of original image data in the step (a).

13. An image data providing apparatus for providing, to a display apparatus including a light source for illuminating a display screen from at least either of front and rear of the display screen, image data that is to be displayed on the display apparatus, the image data providing apparatus comprising:
brightness level calculating means for calculating a brightness level, which is a property regarding brightness of original image data;
brightness adjusting filter determining means for determining a brightness adjusting filter, based on the brightness level calculated by the brightness level calculating means;
brightness adjusting filter transmitting means for transmitting, to the display apparatus, (i) the brightness adjusting filter determined by the brightness adjusting filter determining means, or (ii) filter identification information that identifies the brightness adjusting filter determined by the brightness adjusting filter determining means;
light source adjusting value calculating means for calculating a light source adjusting value used for controlling the light source of the display apparatus such that the light source reduces its luminance according to how much the brightness adjusting filter determined by the brightness adjusting filter determining means increases brightness; and
light source adjusting value transmitting means for transmitting, to the display apparatus, the light source adjusting value calculated by the light source adjusting value calculating means.

14. An image data providing apparatus as set forth in claim 13, comprising:
image transmitting means for transmitting the original image data to the display apparatus.

15. A display apparatus including a light source for illuminating a display screen from at least either of front and rear of the display screen, the display apparatus comprising:
brightness adjusting filter receiving means for receiving, from an image data providing apparatus, a brightness adjusting filter or filter identification information that identifies the brightness adjusting filter;
brightness adjusting means for generating brightness-adjusted image data from original image data by increasing brightness of the original image data by applying (i) the brightness adjusting filter received by the brightness adjusting filter receiving means or (ii) the brightness adjusting filter associated with the filter identification information received by the brightness adjusting filter receiving means;
light source adjusting value receiving means for receiving a light source adjusting value from the image data providing apparatus; and
light source-adjusting means for controlling the light source according to the light source adjusting value received by the light source adjusting value receiving means.

16. A display apparatus as set forth in claim 15, comprising:
image receiving means for receiving the original image data from the image data providing apparatus.

17. A method for controlling an image data providing apparatus for providing, to a display apparatus including a light source for illuminating a display screen from at least either of front and rear of the display screen, image data that is to be displayed on the display apparatus, the method comprising:
(a) calculating a brightness level, which is a property regarding brightness of original image data;
(b) determining a brightness adjusting filter, based on the brightness level calculated in the step (a);
(c) transmitting, to the display apparatus, the brightness adjusting filter determined in the step (b), or filter identification information that identifies the brightness adjusting filter determined in the step (b);
(d) calculating a light source adjusting value used for controlling the light source of the display apparatus such that the light source reduces its luminance according to how much the brightness adjusting filter determined in the step (b) increases brightness; and
(e) transmitting, to the display apparatus, the light source adjusting value calculated in the step (d).

18. A method for controlling a display apparatus including a light source for illuminating a display screen from at least either of front and rear of the display screen, the method comprising:
(a) receiving, from an image data providing apparatus, a brightness adjusting filter or filter identification information that identifies the brightness adjusting filter;
(b) generating brightness-adjusted image data from original image data by increasing brightness of the original image data by applying (i) the brightness adjusting filter received in the step (a) or (ii) the brightness adjusting filter associated with the filter identification information received in the step (a);
(c) receiving a light source adjusting value from the image data providing apparatus; and
(d) controlling the light source according to the light source adjusting value received in the step (c).

19. A computer data signal embodied in a carrier wave, the computer data signal comprising program code of a control program which realizes the image data providing apparatus as set forth in claim 1 by a computer, and causes the computer to function as the respective means.

20. A computer data signal embodied in a carrier wave, the computer data signal comprising program code of a control program which realizes the image data providing apparatus as set forth in claim 7 by a computer, and causes the computer to function as the respective means.

21. A computer data signal embodied in a carrier wave, the computer data signal comprising program code of a control program which realizes the image data providing apparatus as set forth in claim 13 by a computer, and causes the computer to function as the respective means.

22. A computer data signal embodied in a carrier wave, the computer data signal comprising program code of a control program which realizes the display apparatus as set forth in claim 3 by a computer, and causes the computer to function as the respective means.

23. A computer data signal embodied in a carrier wave, the computer data signal comprising program code of a control program which realizes the display apparatus as set forth in claim 9 by a computer, and causes the computer to function as the respective means.

24. A computer data signal embodied in a carrier wave, the computer data signal comprising program code of a control program which realizes the display apparatus as set forth in claim 15 by a computer, and causes the computer to function as the respective means.

25. A computer-readable storage medium storing therein a control program which realizes the image data providing apparatus as set forth in claim 1 by a computer, and causes the computer to function as the respective means.

26. A computer-readable storage medium storing therein a control program which realizes the image data providing apparatus as set forth in claim 7 by a computer, and causes the computer to function as the respective means.

27. A computer-readable storage medium storing therein a control program which realizes the image data providing apparatus as set forth in claim 13 by a computer, and causes the computer to function as the respective means.

28. A computer-readable storage medium storing therein a control program which realizes the display apparatus as set forth in claim 3 by a computer, and causes the computer to function as the respective means.

29. A computer-readable storage medium storing therein a control program which realizes the display apparatus as set forth in claim 9 by a computer, and causes the computer to function as the respective means.

30. A computer-readable storage medium storing therein a control program which realizes the display apparatus as set forth in claim 15 by a computer, and causes the computer to function as the respective means.
